(19) United States
(12) Patent Application Publication
(10) Pub. No.: US 2024/0168321 A1
(43) Pub. Date: May 23, 2024

(54) OPTICAL DEVICE, OPTICAL TRANSMISSION APPARATUS, AND OPTICAL RECEPTION APPARATUS

(71) Applicant: FUJITSU OPTICAL COMPONENTS LIMITED, Kawasaki-shi (JP)

(72) Inventor: Masaki SUGIYAMA, Kawasaki (JP)

(73) Assignee: FUJITSU OPTICAL COMPONENTS LIMITED, Kawasaki-shi (JP)

(21) Appl. No.: 18/485,429

(22) Filed: Oct. 12, 2023

(30) Foreign Application Priority Data
Nov. 22, 2022 (JP) 2022-186901

(51) Int. Cl. G02F 1/01

(52) U.S. Cl. CPC G02F 1/0136

(57) ABSTRACT

An optical device includes a first waveguide that inputs first signal light with a first optical characteristic, and a first convertor that converts the first signal light that travels from the first waveguide into second signal light with a second optical characteristic. The device includes an optical circuit, when the converted second signal light passes through the circuit, performs first optical processing on the second signal light. The device includes a second convertor that converts the second signal light that travels from the circuit and that is subjected to the first processing into third signal light with the first characteristic. The optical device includes the circuit that, when the converted third signal light passes through the circuit, performs second optical processing on the third signal light, and a second waveguide that outputs the third signal light that travels from the circuit and that is subjected to the second processing.

### CROSS-REFERENCE TO RELATED APPLICATION

This application is based upon and claims the benefit of priority of the prior Japanese Patent Application No. 2022-186901, filed on Nov. 22, 2022, the entire contents of which are incorporated herein by reference.

### FIELD

The embodiments discussed herein are related to an optical device, an optical transmission apparatus, and an optical reception apparatus.

### BACKGROUND

FIG. 30 is an explanatory diagram illustrating an example of a conventional optical device 200. The optical device 200 illustrated in FIG. 30 is an optical integrated circuit (IC) chip. The optical device 200 includes a first waveguide 201, a second waveguide 202, and an optical circuit 203. The first waveguide 201 is a waveguide that guides signal light that is input to the optical circuit 203. The second waveguide 202 is a waveguide that guides signal light that is output from the optical circuit 203. The optical circuit 203 converts the signal light that is input from the first waveguide 201 to signal light in a different state in accordance with an external electric signal, and outputs the converted signal light. The optical circuit 203 has functions, such as optical modulation (intensity modulation or phase modulation) function, a light amplification function, a light attenuation function, and the like, for example.
Patent Literature 1: Japanese Laid-open Patent Publication No. 2000-174699
Patent Literature 2: U.S. patent Ser. No. 10/468,854
Patent Literature 3: U.S. Patent Application Publication No. 2020/0133034
Patent Literature 4: Japanese Laid-open Patent Publication No. 2011-197700

In the conventional optical device 200, the functions of the optical circuit 203 are integrated in a limited space, so that performance is limited. If the optical circuit 203 is, for example, an optical modulator, driving voltage of the optical modulator is determined by half-wave shift voltage Vn; however, a product of the half-wave shift voltage Vn and a working length L is determined by an eigenvalue of an element, and therefore, it is needed to increase the working length. However, with the limited working length, there is a limit to how far the driving voltage can be reduced.

Furthermore, if the optical circuit 203 is, for example, a variable optical attenuator (VOA), light absorption per unit length of an electrode length when electric current is applied is small in the variable optical attenuator, and therefore, it is needed to increase the electrode width to increase light attenuation. However, if the electrode length is increased, a size of an element is increased and driving current is increased, so that power consumption is increased. Therefore, in a recent optical device, there is a need to reduce the size and the power consumption.

### SUMMARY

According to an aspect of an embodiment, an optical device includes a first waveguide, a first convertor, an optical circuit, a second convertor and a second waveguide. The first waveguide inputs first signal light with a first optical characteristic. The first convertor is connected to the first waveguide and converts the first signal light that travels from the first waveguide into second signal light with a second optical characteristic. The optical circuit is connected to the first convertor, and when the converted second signal light from the first convertor passes through the optical circuit, performs first optical processing on the second signal light. The second convertor is connected to the optical circuit and converts the second signal light that travels from the optical circuit and that is subjected to the first optical processing into third signal light with the first optical characteristic. The optical circuit, when the converted third signal light from the second convertor passes through the optical circuit, performs second optical processing on the third signal light. The second waveguide outputs the third signal light that travels from the optical circuit and is subjected to the second optical processing.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is an explanatory diagram illustrating an example of an optical device of a first embodiment;

FIG. 2A is an explanatory diagram illustrating an example of an optical device of a second embodiment A;

FIG. 2B is an explanatory diagram illustrating an example of an optical device of a second embodiment B;

FIG. 3 is an explanatory diagram illustrating an example of an optical device of a third embodiment;

FIG. 4 is an explanatory diagram illustrating an example of an optical device of a fourth embodiment;

FIG. 5A is an explanatory diagram illustrating an example of a first mode conversion unit;

FIG. 5B is an explanatory diagram illustrating an example of a second mode conversion unit;

FIG. 6 is an explanatory diagram illustrating an example of an optical device of a fifth embodiment;

FIG. 7 is an explanatory diagram illustrating an example of an optical device of a sixth embodiment;

FIG. 8 is an explanatory diagram illustrating an example of an optical device of a seventh embodiment;

FIG. 9 is an explanatory diagram illustrating an example of an optical device of an eighth embodiment;

FIG. 10 is an explanatory diagram illustrating an example of an optical device of a ninth embodiment;

FIG. 11 is an explanatory diagram illustrating an example of an optical device of a tenth embodiment;

FIG. 12 is a schematic cross-sectional view taken along a line A-A of the optical device illustrated in FIG. 11;

FIG. 13 is an explanatory diagram illustrating an example of an optical device of an eleventh embodiment;

FIG. 14 is a schematic cross-sectional view taken along a line B-B of the optical device illustrated in FIG. 13;

FIG. 15 is an explanatory diagram illustrating an example of an optical device of a twelfth embodiment;

FIG. 16 is a schematic cross-sectional view taken along a line C-C of the optical device illustrated in FIG. 15;

FIG. 17 is an explanatory diagram illustrating an example of an optical device of a thirteenth embodiment;

FIG. 18 is a schematic cross-sectional view taken along a line D-D of the optical device illustrated in FIG. 17;

FIG. 19 is an explanatory diagram illustrating an example of an optical device of a fourteenth embodiment;

FIG. 20 is a schematic cross-sectional view taken along a line E-E of the optical device illustrated in FIG. 19;

FIG. 21 is an explanatory diagram illustrating an example of an optical device of a fifteenth embodiment;

FIG. 22 is a schematic cross-sectional view taken along a line F-F of the optical device illustrated in FIG. 21;

FIG. 23 is an explanatory diagram illustrating an example of an optical device of a sixteenth embodiment;

FIG. 24 is a schematic cross-sectional view taken along a line G-G of the optical device illustrated in FIG. 23;

FIG. 25 is an explanatory diagram illustrating an example of an optical device of a seventeenth embodiment;

FIG. 26 is a schematic cross-sectional view taken along a line H-H of the optical device illustrated in FIG. 25;

FIG. 27 is an explanatory diagram illustrating an example of an optical device of an eighteenth embodiment;

FIG. 28 is an explanatory diagram illustrating an example of an optical device of a nineteenth embodiment;

FIG. 29 is an explanatory diagram illustrating an example of an optical communication apparatus; and

FIG. 30 is an explanatory diagram illustrating an example of a conventional optical device.

### DESCRIPTION OF EMBODIMENTS

Preferred embodiments of the present invention will be explained with reference to accompanying drawings. Meanwhile, the disclosed technology is not limited by the embodiments below. In addition, the embodiments described below may be combined appropriately as long as no contradiction is derived.

### (a) First Embodiment

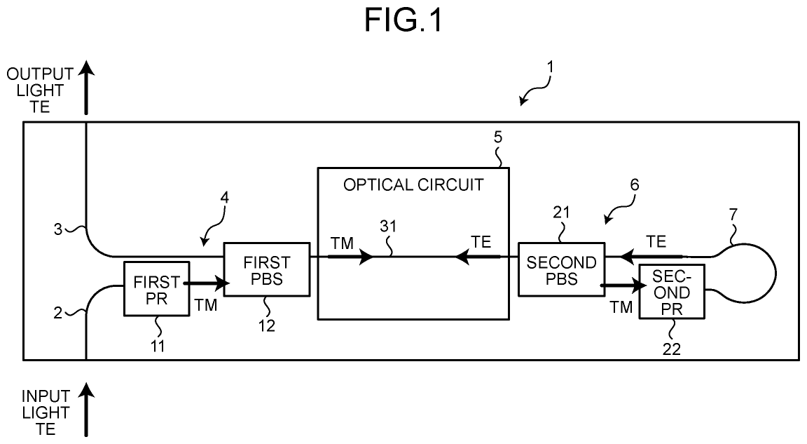

FIG. 1 is an explanatory diagram illustrating an example of an optical device 1 of a first embodiment. The optical device 1 illustrated in FIG. 1 includes a first waveguide 2, a second waveguide 3, a first conversion unit 4, an optical circuit 5, a second conversion unit 6, and a folded waveguide 7.

The first waveguide 2 is, for example, a waveguide that inputs signal light TE (transverse electric field) to the optical device 1. The second waveguide 3 is, for example, a waveguide that outputs signal light TE that is subjected to optical processing from the optical device 1. The signal light TE and a signal light TM (transverse magnetic field) have orthogonal relationships. Meanwhile, if it is assumed that the signal light TE is, for example, signal light with a first optical characteristic, the signal light TM is, for example, signal light with a second optical characteristic.

The first conversion unit 4 includes a first port that is connected to the first waveguide 2, a second port that is connected to the optical circuit 5, and a third port that is connected to the second waveguide 3, and converts the signal light TE that travels from the first waveguide 2 into the signal light TM. The first conversion unit 4 outputs the converted signal light TM to the optical circuit 5.

The optical circuit 5 includes a working part 31 that includes a single waveguide, a first port that connects the first conversion unit 4 and the working part 31, and a second port that connects the second conversion unit 6 and the working part 31. The optical circuit 5 performs, in the working part 31, optical processing on the converted signal light TM that travels from the first conversion unit 4, and outputs the signal light TM that is subjected to the optical processing to the second conversion unit 6.

The second conversion unit 6 includes a fourth port that is connected to the optical circuit 5, a fifth port that is connected to one side of the folded waveguide 7, and a sixth port that is connected to another side of the folded waveguide 7, and converts the signal light TE that travels from the optical circuit 5 and that is subjected to the optical processing into the signal light TM. The second conversion unit 6 outputs the converted signal light TE to the folded waveguide 7. The second conversion unit 6 outputs the signal light TE returned from the folded waveguide 7 to the optical circuit 5.

The optical circuit 5 performs, in the working part 31, optical processing on the converted signal light TE that travels from the second conversion unit 6, and outputs the signal light TE that is subjected to the optical processing to the first conversion unit 4. Further, the first conversion unit 4 outputs the signal light TE that travels from the optical circuit 5 to the second waveguide 3.

The first conversion unit 4 includes a first polarization rotator (PR) 11 and a first polarization beam splitter (PBS) 12. The first PR 11 includes a first port that is connected to the first waveguide 2 and a second port that is connected to the first PBS 12, converts the signal light TE that travels from the first waveguide 2 into the signal light TM, and outputs the converted signal light TM to the first PBS 12. The first PBS 12 includes a first port that is connected to the first PR 11, a second port that is connected to the optical circuit 5, and a third port that is connected to the second waveguide 3. The first PBS 12 splits the signal light that travels from the second port into the signal light TM and the signal light TE, outputs the signal light TM from the first port, and outputs the signal light TE from the third port. In other words, the first PBS 12 outputs the signal light TM that travels from the first PR 11 to the optical circuit 5, and outputs the signal light TE that travels from the optical circuit 5 to the second waveguide 3.

The second conversion unit 6 includes a second PBS 21 and a second PR 22. The second PBS 21 includes a fourth port that is connected to the optical circuit 5, a fifth port that is connected to the second PR 22, a sixth port that is connected to the folded waveguide 7. The second PBS 21 splits the signal light that travels from the fourth port into the signal light TM and the signal light TE, outputs the signal light TM from the fifth port, and outputs the signal light TE from the sixth port. In other words, the second PBS 21 outputs the signal light TM that travels from the optical circuit 5 to the second PR 22, and outputs the signal light TE that travels from the folded waveguide 7 to the optical circuit 5. The second PR 22 includes a first port that is connected to the second PBS 21 and a second port that is connected to the folded waveguide 7, converts the signal light TM that travels from the second PBS 21 into the signal light TE, and outputs the converted signal light TE to the folded waveguide 7.

The optical circuit 5 performs optical processing twice in total by performing optical processing on the signal light TM that travels from the first conversion unit 4 to the second conversion unit 6 and performing optical processing on the signal light TE that travels from the second conversion unit 6 to the first conversion unit 4. As a result, it is possible to double the functions of the optical circuit 5 at a maximum, reduce power consumption, and reduce a size of the optical device 1. In other words, it is possible to improve efficiency of the optical circuit 5.

Meanwhile, for convenience of explanation, the example has been described in which the optical device 1 of the first embodiment includes the first conversion unit 4 that is connected to one end of the optical circuit 5 and the second conversion unit 6 that is connected to the other end of the optical circuit 5. However, it may be possible to connect the second conversion unit 6 to the same one end of the optical circuit 5 as the first conversion unit 4, and this embodiment will be described below as a second embodiment A.

### (b) Second Embodiment

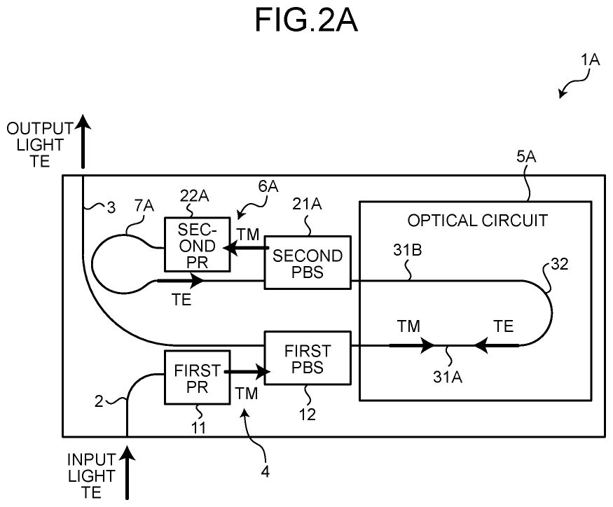

FIG. 2A is an explanatory diagram illustrating an example of an optical device 1A of a second embodiment A. Meanwhile, the same components as those of the optical device 1 of the first embodiment will be denoted by the same reference symbols, and explanation of the same configurations and the same operation will be omitted. The optical device 1A illustrated in FIG. 2A includes the first waveguide 2, the second waveguide 3, the first conversion unit 4, an optical circuit 5A, a second conversion unit 6A, and a folded waveguide 7A. The optical circuit 5A includes a forward-side working part 31A, a backward-side working part 31B, and a folded waveguide 32 that optically couples the forward-side working part 31A and the backward-side working part 31B.

The first conversion unit 4 includes a first port that is connected to the first waveguide 2, a second port that is connected to the optical circuit 5A, and a third port that is connected to the second waveguide 3, converts the signal light TE that travels from the first waveguide 2 into the signal light TM, and outputs the converted signal light TM to the optical circuit 5A.

The optical circuit 5A includes a first port that connects the first conversion unit 4 and the forward-side working part 31A, and a second port that connects the second conversion unit 6A and the backward-side working part 31B. The optical circuit 5A performs optical processing on the converted signal light TM that travels from the first conversion unit 4, and outputs the signal light TM that is subjected to the optical processing to the second conversion unit 6A. The forward-side working part 31A includes a forward-side waveguide and performs optical processing, by an electric signal, on the signal light that is guided by the forward-side waveguide. Further, the backward-side working part 31B includes a backward-side waveguide and performs optical processing, by an electric signal, on the signal light that is guided by the backward-side waveguide.

The second conversion unit 6A includes a fourth port that is connected to the backward-side working part 31B in the optical circuit 5A, a fifth port that is connected to one side of the folded waveguide 7A, and a sixth port that is connected to another side of the folded waveguide 7A. The second conversion unit 6A converts the signal light TM that travels from the optical circuit 5A and that is subjected to the optical processing into the signal light TE, and outputs the converted signal light TE to the backward-side working part 31B in the optical circuit 5.

The optical circuit 5A performs optical processing on the converted signal light TE that travels from the second conversion unit 6A, and outputs the signal light TE that is subjected to the optical processing to the first conversion unit 4. Further, the first conversion unit 4 outputs the signal light TE that travels from the forward-side working part 31A in the optical circuit 5A to the second waveguide 3.

The first conversion unit 4 includes the first PR 11 and the first PBS 12. The first PR 11 includes a first port that is connected to the first waveguide 2 and a second port that is connected to the first PBS 12, converts the signal light TE that travels from the first waveguide 2 into the signal light TM, and outputs the converted signal light TM to the first PBS 12.

The first PBS 12 includes a first port that is connected to the first PR 11, a second port that is connected to the forward-side working part 31A in the optical circuit 5A, and a third port that is connected to the second waveguide 3. The first PBS 12 splits the signal light that travels from the second port into the signal light TM and the signal light TE, outputs the signal light TM from the first port, and outputs the signal light TE from the third port. In other words, the first PBS 12 outputs the converted signal light TM that travels from the first PR 11 to the forward-side working part 31A in the optical circuit 5, and outputs the signal light TE that travels from the forward-side working part 31A in the optical circuit 5A to the second waveguide 3.

The second conversion unit 6A includes a second PBS 21A and a second PR 22A. The second PBS 21A includes a fourth port that is connected to the backward-side working part 31B in the optical circuit 5A, a fifth port that is connected to the second PR 22A, and a sixth port that is connected to the folded waveguide 7A. The second PBS 21A splits the signal light that travels from the fourth port into the signal light TM and the signal light TE, outputs the signal light TM from the fifth port, and outputs the signal light TE from the sixth port. In other words, the second PBS 21A outputs the signal light TM that travels from the backward-side working part 31B in the optical circuit 5A to the second PR 22A, and outputs the signal light TE that travels from the folded waveguide 7A to the backward-side working part 31B in the optical circuit 5A.

The second PR 22A includes a first port that is connected to the second PBS 21A and a second port that is connected to the folded waveguide 7A, converts the signal light TM that travels from the second PBS 21A into the signal light TE, and outputs the converted signal light TE to the folded waveguide 7A.

The optical circuit 5A performs optical processing twice in total by performing optical processing on the signal light TM that travels from the first conversion unit 4 and performing optical processing on the signal light TE that travels from the second conversion unit 6A. As a result, it is possible to double the functions of the optical circuit 5A at a maximum, reduce power consumption, and reduce a size of the optical device 1A.

In the optical device 1A of the second embodiment A, if a waveguide length in the optical circuit 5A is increased, the first conversion unit 4 and the second conversion unit 6A are arranged parallel to each other on a prior stage and a posterior stage of the optical circuit 5A, so that it is possible to reduce the size of the optical device 1A.

Meanwhile, in the optical circuit 5A of the optical device 1A of the second embodiment A, the example has been described in which the first conversion unit 4 converts the signal light TE into the signal light TM and the second conversion unit 6A converts the signal light TM into the signal light TE, that is, the light is converted into orthogonally polarized waves. However, embodiments are not limited to this example, and the technology is applicable to a case in which the light is converted to an orthogonal higher-order mode. Therefore, this embodiment will be described below as a second embodiment B.

FIG. 2B is an explanatory diagram illustrating an example of an optical device 1X of the second embodiment B. Meanwhile, the same components as those of the optical device 1A of the second embodiment A will be denoted by the same reference symbols, and explanation of the same configurations and the same operation will be omitted. The optical device 1X illustrated in FIG. 2B includes the first waveguide 2, the second waveguide 3, a first mode conversion unit 8 as a first conversion unit 4X, the optical circuit 5A, a second mode conversion unit 9 as a second conversion unit 6X, and the folded waveguide 7A. The optical circuit 5A has the same configuration as the optical circuit illustrated in FIG. 2A.

The first mode conversion unit 8 is a mode convertor and combiner. The first mode conversion unit 8 includes a first port that is connected to the first waveguide 2, a second port that is connected to the optical circuit 5A, and a third port that is connected to the second waveguide 3, performs higher-order mode conversion on the signal light TE0 that travels from the first waveguide 2 to obtain signal light TE1, and outputs the signal light TE1 that is subjected to the higher-order mode conversion to the optical circuit 5A. Meanwhile, the signal light TE0 and the signal light TE1 have orthogonal relationships. Meanwhile, if it is assumed that the signal light TE0 is, for example, the signal light with the first optical characteristic, the signal light TE1 is, for example, the signal light with the second optical characteristic.

The optical circuit 5A includes a first port that connects the first mode conversion unit 8 and the forward-side working part 31A, and a second port that connects the second mode conversion unit 9 and the backward-side working part 31B. The optical circuit 5A performs optical processing on the mode-converted signal light TE1 that travels from the first mode conversion unit 8, and outputs the signal light TE1 that is subjected to the optical processing to the second mode conversion unit 9. The forward-side working part 31A includes a forward-side waveguide and performs optical processing, by an electric signal, on the signal light that is guided by the forward-side waveguide. Further, the backward-side working part 31B includes a backward-side waveguide and performs optical processing, by an electric signal, on the signal light that is guided by the backward-side waveguide.

The second mode conversion unit 9 is a mode convertor and combiner. The second mode conversion unit 9 includes a fourth port that is connected to the backward-side working part 31B in the optical circuit 5A, a fifth port that is connected to one side of the folded waveguide 7A, and a sixth port that is connected to another side of the folded waveguide 7A. The second mode conversion unit 9 converts the signal light TE1 that travels from the optical circuit 5A and that is subjected to the optical processing into the signal light TE0, and outputs the converted signal light TE0 to the backward-side working part 31B in the optical circuit 5A.

The optical circuit 5A performs optical processing on the converted signal light TE0 that travels from the second mode conversion unit 9, and outputs the signal light TE0 that is subjected to the optical processing to the first mode conversion unit 8. Further, the first mode conversion unit 8 outputs the signal light TE0 that travels from the forward-side working part 31A in the optical circuit 5A to the second waveguide 3.

The optical circuit 5A performs optical processing twice in total by performing optical processing on the signal light TE1 that travels from the first mode conversion unit 8 and performing optical processing on the signal light TE0 that travels from the second mode conversion unit 9. As a result, it is possible to double the functions of the optical circuit 5A, reduce power consumption, and reduce a size of the optical device 1X.

In the optical device 1X of the second embodiment B, if the waveguide length in the optical circuit 5A is increased, the first mode conversion unit 8 and the second mode conversion unit 9 are arranged parallel to each other on the prior stage and the posterior stage of the optical circuit 5A, so that it is possible to reduce the size of the optical device 1X.

Meanwhile, in the optical device 1A of the second embodiment A, the signal light TM that travels from the first conversion unit 4 and the signal light TE that travels from the second conversion unit 6A, both of which pass through the optical circuit 5A, travel in opposite directions. Therefore, for example, due to incompleteness of the first PBS 12 and the first PR 11, in some cases, reflected return light that is the return signal light TE may travel through the first waveguide 2 in the opposite direction. Therefore, an embodiment of an optical device that is able to prevent the reflected return light as described above will be described below as a third embodiment.

### (c) Third Embodiment

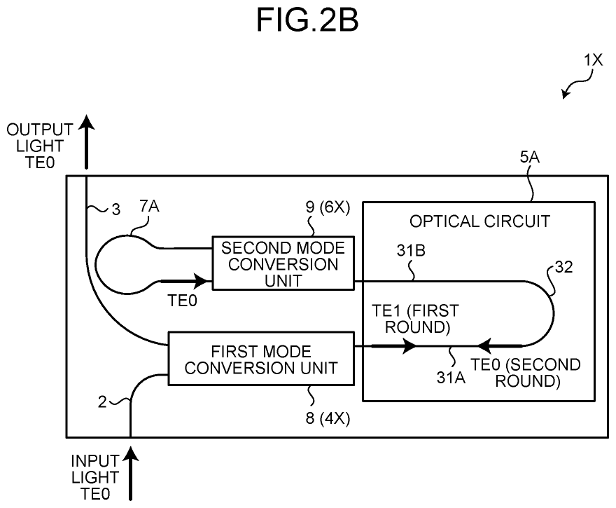

FIG. 3 is an explanatory diagram illustrating an example of an optical device 1B of the third embodiment. Meanwhile, the same components as those of the optical device 1A of the second embodiment A will be denoted by the same reference symbols, and explanation of the same configurations and the same operation will be omitted. The optical device 1B illustrated in FIG. 3 includes the first waveguide 2, the second waveguide 3, the first conversion unit 4, the optical circuit 5A, a second conversion unit 6B, and a folded waveguide 7B. The optical circuit 5A includes the forward-side working part 31A, the backward-side working part 31B, and the folded waveguide 32 that optically couples the forward-side working part 31A and the backward-side working part 31B.

The first conversion unit 4 includes a first port that is connected to the first waveguide 2, a second port that is connected to the optical circuit 5A, and a third port that is connected to the folded waveguide 7B. The first conversion unit 4 converts the signal light TE that travels from the first waveguide 2 into the signal light TM, and outputs the converted signal light TM to the optical circuit 5A.

The optical circuit 5A includes a first port that connects the first conversion unit 4 and the forward-side working part 31A and a second port that connects the second conversion unit 6B and the backward-side working part 31B. The optical circuit 5A performs optical processing on the converted signal light TM that travels from the first conversion unit 4, and outputs the signal light TM that is subjected to the optical processing to the second conversion unit 6B.

The second conversion unit 6B includes a fourth port that is connected to the backward-side working part 31B in the optical circuit 5A, a fifth port that is connected to the folded waveguide 7B, and a sixth port that is connected to the second waveguide 3. The second conversion unit 6B converts the signal light TM that travels from the optical circuit 5A and that is subjected to the optical processing into the signal light TE, and outputs the converted signal light TE to the folded waveguide 7B. The first conversion unit 4 outputs the converted signal light TE that travels from the folded waveguide 7B to the forward-side working part 31A in the optical circuit 5A.

The optical circuit 5A performs optical processing on the converted signal light TE that travels from the second conversion unit 6B, and outputs the signal light TE that is subjected to the optical processing to the second conversion unit 6B. Further, the second conversion unit 6B outputs the signal light TE that travels from the backward-side working part 31B in the optical circuit 5A to the second waveguide 3.

The first conversion unit 4 includes the first PR 11 and the first PBS 12. The first PR 11 includes a first port that is connected to the first waveguide 2 and a second port that is connected to the first PBS 12. The first PR 11 converts the signal light TE that travels from the first waveguide 2 into the signal light TM, and outputs the converted signal light TM to the first PBS 12.

The first PBS 12 includes a first port that is connected to the first PR 11, a second port that is connected to the forward-side working part 31A in the optical circuit 5A, and a third port that is connected to the folded waveguide 7B. The first PBS 12 splits the signal light that travels from the second port into the signal light TM and the signal light TE, outputs the signal light TM from the first port, and outputs the signal light TE from the third port. In other words, the first PBS 12 outputs the signal light TM that travels from the first PR 11 to the forward-side working part 31A in the optical circuit 5A, and outputs the signal light TE that travels from the folded waveguide 7B to the forward-side working part 31A in the optical circuit 5A.

The second conversion unit 6B includes a second PBS 21B and a second PR 22B. The second PBS 21B includes a fourth port that is connected to the backward-side working part 31B in the optical circuit 5A, a fifth port that is connected to the second PR 22B, and a sixth port that is connected to the second waveguide 3. The second PBS 21B splits the signal light that travels from the fourth port into the signal light TM and the signal light TE, outputs the signal light TM from the fifth port, and outputs the signal light TE from the sixth port. In other words, the second PBS 21B outputs the signal light TM that travels from the backward-side working part 31B in the optical circuit 5A to the second PR 22B, and outputs the signal light TE that travels from the backward-side working part 31B in the optical circuit 5A to the second waveguide 3.

The second PR 22B includes a first port that is connected to the second PBS 21B and a second port that is connected to the folded waveguide 3, converts the signal light TM that travels from the second PBS 21B into the signal light TE, and outputs the converted signal light TE to the folded waveguide 7B.

The optical circuit 5A performs optical processing twice in total in the same traveling direction by performing optical processing on the signal light TM that travels from the first conversion unit 4 and performing optical processing on the signal light TE that travels from the second conversion unit 6B via the first conversion unit 4. As a result, it is possible to double the functions of the optical circuit 5A, reduce power consumption, reduces a size of the optical device 1B, and reduce an influence of the reflected return light.

In the optical device 1B of the third embodiment, if the waveguide length in the optical circuit 5A is increased, the first conversion unit 4 and the second conversion unit 6B are arranged parallel to each other on the prior stage and the posterior stage of the optical circuit 5A, so that it is possible to reduce the size of the optical device 1B.

In the optical device 1B, the second PR 22B on the posterior stage of the optical circuit 5A is connected to the first PBS 12 on the prior stage of the optical circuit 5A; therefore, the signal light passes through the waveguide in the optical circuit 5A in the same traveling direction such that the signal light TM firstly passes through the waveguide and the signal light TE secondly passes through the waveguide, so that it is possible to reduce an influence of the reflected return light. It is possible to prevent a situation in which the reflected return light of the folded signal light TE affects the signal light TE that is input from the first waveguide 2. Further, it is possible to prevent a situation in which the reflected return light of the folded signal light TM affects the first signal light TM that passes through the optical circuit 5A.

Meanwhile, in the optical circuit 5A of the optical device 1B of the third embodiment, the example has been described in which the first conversion unit 4 converts the signal light TE to the signal light TM and the second conversion unit 6B convers the signal light TM into the signal light TE, that is, the light is converted into orthogonally polarized waves. However, embodiments are not limited to this example, and the technology is applicable to a case in which the light is converted to an orthogonal higher-order mode. Therefore, this embodiment will be described below as a fourth embodiment.

### (d) Fourth Embodiment

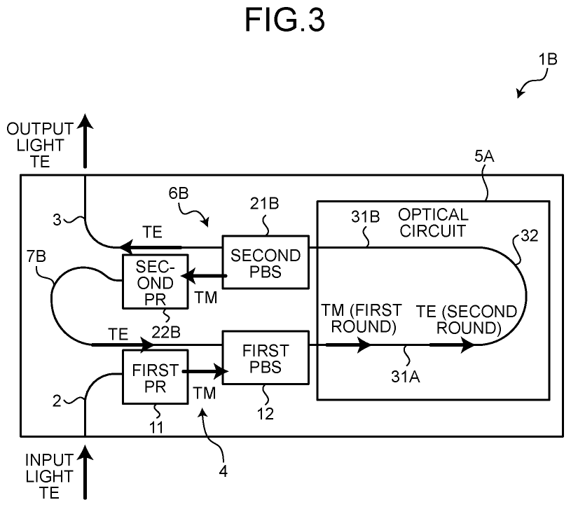

FIG. 4 is an explanatory diagram illustrating an example of an optical device 1C of the fourth embodiment. Meanwhile, the same components as those of the optical device 1B of the third embodiment will be denoted by the same reference symbols, and explanation of the same configurations and the same operation will be omitted. The optical device 1C illustrated in FIG. 4 includes the first waveguide 2, the first mode conversion unit 8 as a first conversion unit 4C, the optical circuit 5A, the second mode conversion unit 9 as a second conversion unit 6C, a folded waveguide 7C, and the second waveguide 3. The optical circuit 5A has the same configuration as the optical circuit illustrated in FIG. 3.

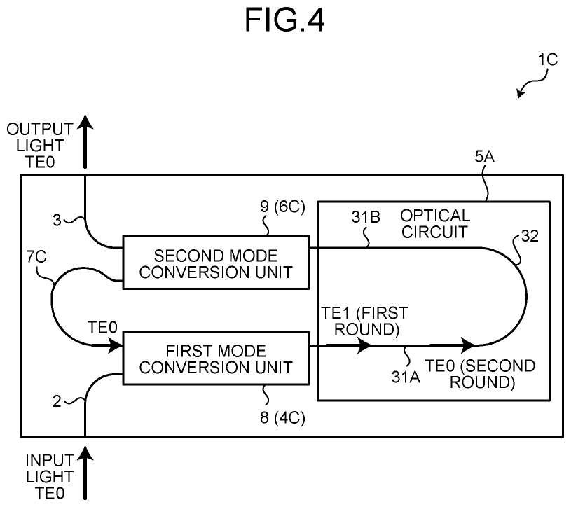

FIG. 5A is an explanatory diagram illustrating an example of the first mode conversion unit 8. The first mode conversion unit 8 is a mode convertor and combiner. The first mode conversion unit 8 includes a first port that is connected to the first waveguide 2, a second port that is connected to the forward-side working part 31A in the optical circuit 5A, and a third port that is connected to the folded waveguide 7C. The first mode conversion unit 8 performs, for example, mode conversion on the signal light TE0 and obtains the signal light TE1. Meanwhile, the signal light TE0 and the signal light TE1 have orthogonal relationships. The first mode conversion unit 8 performs higher-order mode conversion on the signal light TE0 that travels from the first waveguide 2 to obtain the signal light TE1, and outputs the signal light TE1 that is subjected to the higher-order mode conversion to the forward-side working part 31A in the optical circuit 5A. The first mode conversion unit 8 outputs the signal light TE0 that travels from the folded waveguide 7C to the forward-side working part 31A in the optical circuit 5A.

The optical circuit 5A includes a first port that connects the first mode conversion unit 8 and the forward-side working part 31A, and a second port that connects the second mode conversion unit 9 and the backward-side working part 31B. The optical circuit 5A performs optical processing on the converted first signal light TE1 that travels from the first mode conversion unit 8, and outputs the signal light TE1 that is subjected to the optical processing to the second mode conversion unit 9. Further, the optical circuit 5A performs optical processing on the second signal light TE0 that travels from the second mode conversion unit 9 via the first mode conversion unit 8, and outputs the signal light TE0 that is subjected to the optical processing to the second mode conversion unit 9.

FIG. 5B is an explanatory diagram illustrating an example of the second mode conversion unit 9. The second mode conversion unit 9 includes a fourth port that is connected to the backward-side working part 31B in the optical circuit 5A, a fifth port that is connected to the folded waveguide 7C, and a sixth port that is connected to the second waveguide 3. The second mode conversion unit 9 performs, for example, mode conversion on the signal light TE1 and obtains the signal light TE0. The second mode conversion unit 9 converts the first signal light TE1 that travels from the backward-side working part 31B in the optical circuit 5A and that is subjected to the optical processing into the signal light TE0. The second mode conversion unit 9 outputs the converted signal light TEC to the first mode conversion unit 8 via the folded waveguide 7C. The second mode conversion unit 9 outputs the second signal light TE0 that travels from the optical circuit 5A and that is subjected to the optical processing to the second waveguide 3.

In other words, the optical circuit 5A performs optical processing twice in total in the same traveling direction by performing optical processing on the first signal light TE1 that travels from the first mode conversion unit 8 and performing optical processing on the second signal light TE0 that travels from the second mode conversion unit 9 via the first mode conversion unit 8. As a result, even in the higher-order mode, it is possible to double the functions of the optical circuit 5A, reduce power consumption, reduce the size of the optical device 1C, and reduce an influence of the reflected return light.

In the optical device 1C of the fourth embodiment, if the waveguide length in the optical circuit 5A is increased, the first mode conversion unit 8 and the second mode conversion unit 9 are arranged parallel to each other on the prior stage and the posterior stage of the optical circuit 5A, so that it is possible to reduce a size of the optical device 1C.

### (e) Fifth Embodiment

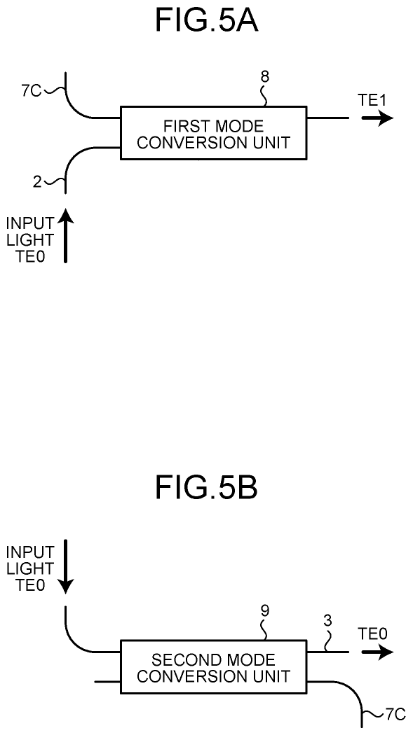

FIG. 6 is an explanatory diagram illustrating an example of an optical device 1D of a fifth embodiment. Meanwhile, the same components as those of the optical device 1B of the third embodiment will be denoted by the same reference symbols, and explanation of the same configurations and the same operation will be omitted. The optical device 1D illustrated in FIG. 6 is different from the optical device 1B illustrated in FIG. 3 in that a channel waveguide in the forward-side working part 31A and a channel waveguide in the backward-side working part 31B are optically coupled with each other by a folded rib waveguide 32D.

An optical circuit 5D is configured such that the channel waveguide in the forward-side working part 31A and the channel waveguide in the backward-side working part 31B are optically coupled with each other by the folded rib waveguide 32D, so that it is possible to reduce a size of the optical circuit 5D.

### (f) Sixth Embodiment

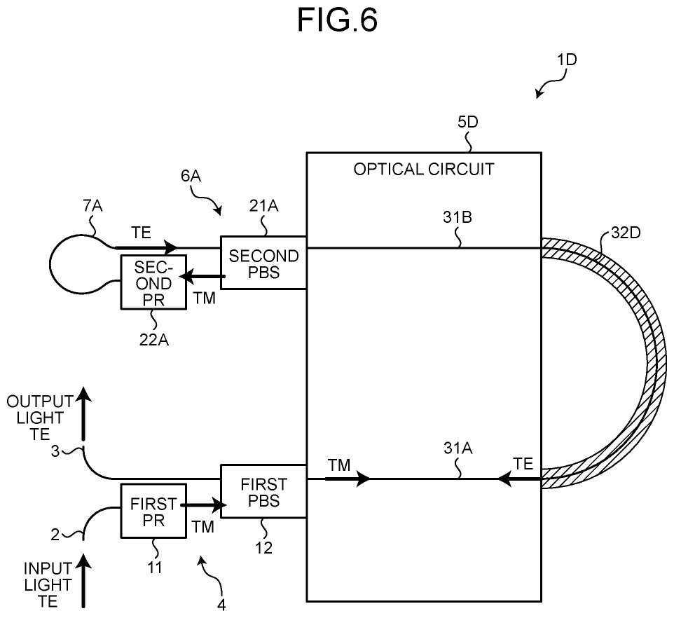

FIG. 7 is an explanatory diagram illustrating an example of an optical device 1E of a sixth embodiment. Meanwhile, the same components as those of the optical device 1B of the third embodiment will be denoted by the same reference symbols, and explanation of the same configurations and the same operation will be omitted. The optical device 1E illustrated in FIG. 7 is different from the optical device 1B illustrated in FIG. 3 in that the channel waveguide in the forward-side working part 31A and the channel waveguide in the backward-side working part 31B are optically coupled with each other by a folded channel waveguide 32E.

The optical circuit 5D is configured such that the channel waveguide in the forward-side working part 31A and the channel waveguide in the backward-side working part 31B are optically coupled with each other by the folded channel waveguide 32E, so that it is possible to reduce a size of the optical circuit 5D. In addition, the folded channel waveguide 32E is able to increase optical confinement and reduce a bending loss.

### (g) Seventh Embodiment

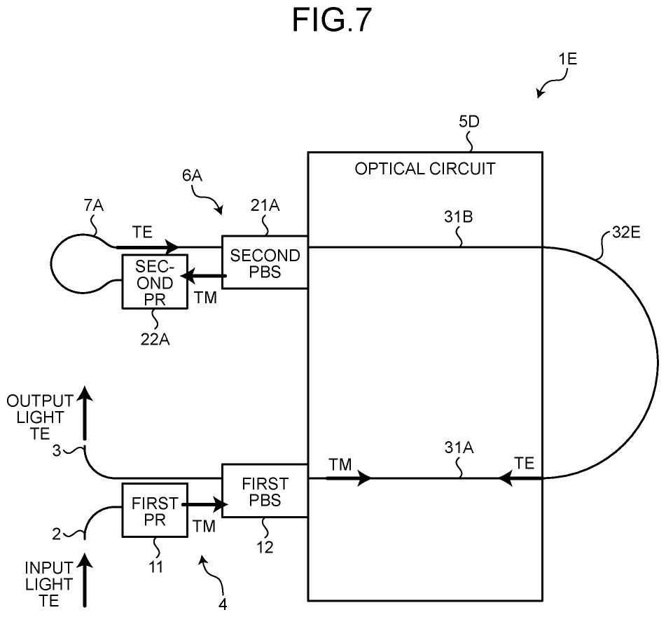

FIG. 8 is an explanatory diagram illustrating an example of an optical device 1F of a seventh embodiment. Meanwhile, the same components as those of the optical device 1B of the third embodiment will be denoted by the same reference symbols, and explanation of the same configurations and the same operation will be omitted. An optical circuit 5F in the optical device 1F illustrated in FIG. 8 includes a forward-side working part 31A1, a backward-side working part 31B1, and the folded channel waveguide 32E that optically couples the forward-side working part 31A1 and the backward-side working part 31B1.

The forward-side working part 31A1 includes a forward-side first conversion waveguide 33A1, a forward-side rib waveguide, and a forward-side second conversion waveguide 33A2. The forward-side first conversion waveguide 33A1 is a waveguide that connects a channel waveguide at the side of the first PBS 12 and the forward-side rib waveguide, and that has a tapered shape in which a slab width is gradually increased from the channel waveguide to the forward-side rib waveguide. The forward-side second conversion waveguide 33A2 is a waveguide that connects the forward-side rib waveguide and the folded channel waveguide 32E, and that has a tapered shape in which a slab width is gradually reduced from the forward-side rib waveguide to the channel waveguide.

The backward-side working part 31B1 includes a backward-side first conversion waveguide 33B1, a backward-side rib waveguide, and a backward-side second conversion waveguide 33B2. The backward-side first conversion waveguide 33B1 is a waveguide that connects a channel waveguide at the side of the second PBS 21A and the backward-side rib waveguide, and that has a tapered shape in which a slab width is gradually reduced from the backward-side rib waveguide to the channel waveguide. The backward-side second conversion waveguide 33B2 is a waveguide that connects the backward-side rib waveguide and the folded channel waveguide 32E, and that has a tapered shape in which a slab width is gradually increased from the channel waveguide.

In the optical device 1F, the forward-side working part 31A1 and the backward-side working part 31B1 are optically coupled with each other by the folded channel waveguide 32E. Therefore, the folded channel waveguide 32E increases optical confinement, so that even if a curvature radius of the folded channel waveguide 32E is reduced, it is possible to return the signal light without increasing an optical loss at a bending radius.

In addition, in the optical circuit 5F, the waveguide having the tapered shape in which the slab width is gradually changed is arranged between the channel waveguide and the rib waveguide, so that it is possible to prevent an optical loss that may occur between the rib waveguide and the channel waveguide.

### (h) Eighth Embodiment

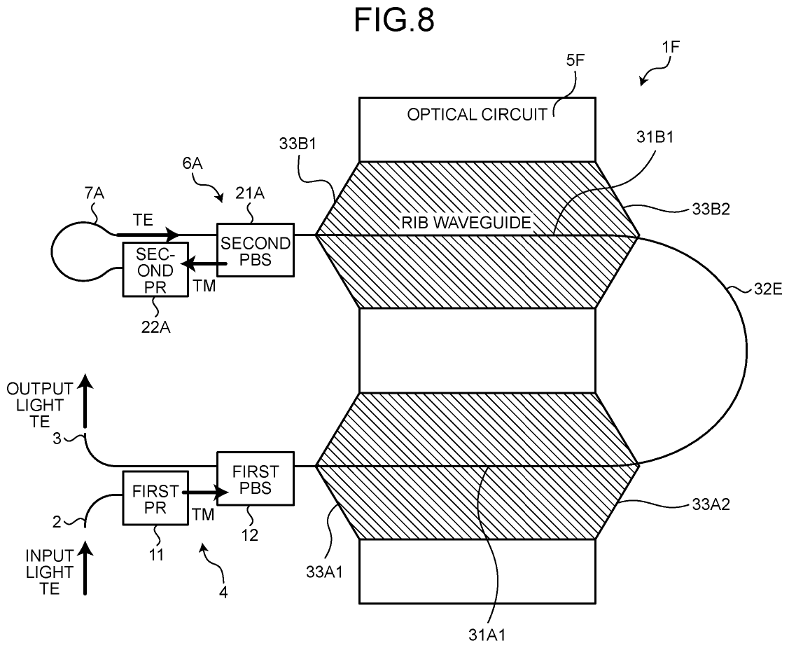

FIG. 9 is an explanatory diagram illustrating an example of an optical device 1G of an eighth embodiment. The optical device 1G illustrated in FIG. 9 includes the first waveguide 2, the second waveguide 3, the first conversion unit 4, a first folded channel waveguide 10A, the optical circuit 5A, a second folded channel waveguide 10B, a second conversion unit 6G, and a folded waveguide 7G. The optical circuit 5A includes the forward-side working part 31A including the forward-side channel waveguide, the backward-side working part 31B including the backward-side channel waveguide, and the folded channel waveguide 32E that optically couples the forward-side working part 31A and the backward-side working part 31B with each other.

The first conversion unit 4 includes a first port that is connected to the first waveguide 2, a second port that is connected to the first folded channel waveguide 10A, and a third port that is connected to the folded waveguide 7G. The first conversion unit 4 converts the signal light TE that travels from the first waveguide 2 into the signal light TM. The first conversion unit 4 outputs the converted signal light TM to the first folded channel waveguide 10A. The first folded channel waveguide 10A is connected to the forward-side working part 31A in the optical circuit 5A.

The optical circuit 5A includes a first port that connects the first folded channel waveguide 10A and the forward-side working part 31A and a second port that connects the second folded channel waveguide 10B and the backward-side working part 31B. The optical circuit 5A performs optical processing on the converted signal light TM that travels from the first folded channel waveguide 10A, and outputs the signal light TM that is subjected to the optical processing to the second conversion unit 6G.

The second conversion unit 6G includes a fourth port that is connected to the second folded channel waveguide 10B, a fifth port that is connected to the folded waveguide 7G, and a sixth port that is connected to the second waveguide 3. The second conversion unit 6G converts the signal light TM that travels from the second folded channel waveguide 10B and that is subjected to the optical processing into the signal light TE, and outputs the converted signal light TE to the first folded channel waveguide 10A via the folded waveguide 7G and the first conversion unit 4. The second folded channel waveguide 10B is connected to the backward-side working part 31B in the optical circuit 5A.

The optical circuit 5A performs optical processing on the signal light TE that travels from the first folded channel waveguide 10A and that is converted by the second conversion unit 6G, and outputs the signal light TE that is subjected to the optical processing to the second conversion unit 6G. Further, the second conversion unit 6G outputs the signal light TE that travels from the backward-side working part 31B in the optical circuit 5A to the second waveguide 3.

The first conversion unit 4 includes the first PR 11 and the first PBS 12. The first PR 11 includes a first port that is connected to the first waveguide 2 and a second port that is connected to the first PBS 12. The first PR 11 converts the signal light TE that travels from the first waveguide 2 into the signal light TM, and outputs the converted signal light TM to the first PBS 12.

The first PBS 12 includes a first port that is connected to the first PR 11, a second port that is connected to the first folded channel waveguide 10A, and a third port that is connected to the folded waveguide 7G. The first PBS 12 outputs the signal light TM that travels from the first PR 11 to the first folded channel waveguide 10A, and outputs the signal light TE that travels from the folded waveguide 7G to the first folded channel waveguide 10A.

The second conversion unit 6G includes a second PBS 21G and a second PR 22G. The second PBS 21G includes a fourth port that is connected to the second folded channel waveguide 10B, a fifth port that is connected to the second PR 22G, and a sixth port that is connected to the second waveguide 3. The second PBS 21G outputs the signal light TM that travels from the second folded channel waveguide 10B to the second PR 22G, and outputs the signal light TE that travels from the second folded channel waveguide 10B to the second waveguide 3.

The second PR 22G includes a first port that is connected to the second PBS 21G and a second port that is connected to the folded waveguide 7G. The second PR 22G converts the signal light TM that travels from the second PBS 21G into the signal light TE, and outputs the converted signal light TE to the folded waveguide 7G.

The optical circuit 5A performs optical processing twice in total in the same traveling direction by performing optical processing on the first signal light TM that travels from the first folded channel waveguide 10A and performing optical processing on the second signal light TE that travels from the first folded channel waveguide 10A. As a result, it is possible to double the functions of the optical circuit 5A, reduce power consumption, reduce a size of the optical device 1G, and reduce an influence of the reflected return light.

In the optical device 1G of the eighth embodiment, the second PR 22G on the posterior stage of the optical circuit 5A is connected to the first PBS 12 on the prior stage of the optical circuit 5A. As a result, the signal light passes through a PIN diode area of the working part in the optical circuit 5A in the same traveling direction such that the signal light TM firstly passes and the signal light TE secondly passes, so that it is possible to reduce an influence of the reflected return light. In other words, it is possible to prevent a situation in which the reflected return light of the folded signal light TE0 affects the signal light TE0 that is input from the first waveguide 2. Further, it is possible to prevent a situation in which the reflected return light of the folded signal light TE1 affects the first signal light TE1 that passes through the optical circuit 5A.

Furthermore, the optical device 1G is configured such that the first conversion unit 4, the optical circuit 5A, and the second conversion unit 6G are arranged parallel to one another, so that it is possible to reduce the size of the optical device 1G.

### (i) Ninth Embodiment

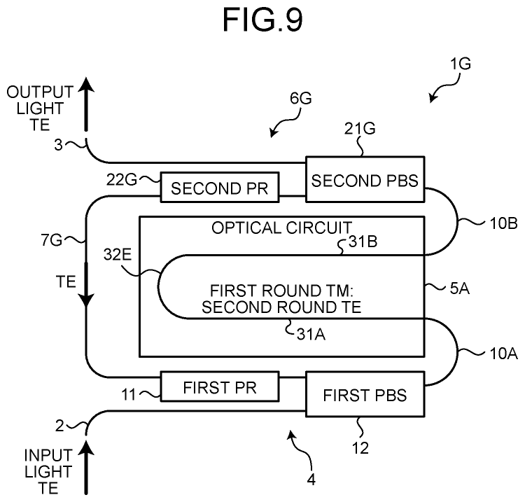

FIG. 10 is an explanatory diagram illustrating an example of an optical device 1H of a ninth embodiment. The optical device 1H illustrated in FIG. 10 includes the first waveguide 2, the second waveguide 3, a first mode conversion unit 8A, a first folded rib waveguide 10A1, the optical circuit 5A, a second folded rib waveguide 10B1, a second mode conversion unit 9A, and the folded waveguide 7G. The optical circuit 5A includes the forward-side working part 31A, the backward-side working part 31B, and the folded channel waveguide 32E that optically couples the forward-side working part 31A and the backward-side working part 31B with each other.

The first mode conversion unit 8A includes a first port that is connected to the first waveguide 2, a second port that is connected to the first folded rib waveguide 10A1, and a third port that is connected to the folded waveguide 7G. The first mode conversion unit 8A performs higher-order mode conversion on the signal light TE0 that travels from the first waveguide 2 and obtains the signal light TE1. The first mode conversion unit 8A outputs the converted signal light TE1 to the first folded rib waveguide 10A1. The first folded rib waveguide 10A1 is connected to the forward-side working part 31A in the optical circuit 5A.

The optical circuit 5A includes a first port that connects the first folded rib waveguide 10A1 and the forward-side working part 31A, and a second port that connects the second folded rib waveguide 10B1 and the backward-side working part 31B. The optical circuit 5A performs optical processing on the converted signal light TE1 that travels from the first mode conversion unit 8A, and outputs the signal light TE1 that is subjected to the optical processing to the second mode conversion unit 9A.

The second mode conversion unit 9A includes a fourth port that is connected to the second folded rib waveguide 10B1, a fifth port that is connected to the folded waveguide 7G, and a sixth port that is connected to the second waveguide 3. The second mode conversion unit 9A converts the signal light TE1 that travels from the second folded rib waveguide 10B1 and that is subjected to the optical processing into the signal light TE0, and outputs the converted signal light TE0 to the first folded rib waveguide 10A1 via the folded waveguide 7G and the first mode conversion unit 8A. The second folded rib waveguide 10B1 is connected to the backward-side working part 31B in the optical circuit 5A.

The optical circuit 5A performs optical processing on the signal light TE0 that travels from the first mode conversion unit 8A and that is converted by the second mode conversion unit 9A, and outputs the signal light TE0 that is subjected to the optical processing to the second mode conversion unit 9A. Further, the second mode conversion unit 9A outputs the second signal light TE0 that travels from the second folded rib waveguide 10B1 to the second waveguide 3.

The optical circuit 5A performs optical processing twice in total in the same traveling direction by performing optical processing on the first signal light TE1 that travels from the first folded rib waveguide 10A1 and performing optical processing on the second signal light TE0 that travels from the first folded rib waveguide 10A1. As a result, it is possible to double the functions of the optical circuit 5A, reduce power consumption, reduce a size of the optical device 1H, and reduce an influence of the reflected return light.

In the optical device 1H of the ninth embodiment, the second mode conversion unit 9A on the posterior stage of the optical circuit 5A is connected to the first mode conversion unit 8A on the prior stage of the optical circuit 5A. As a result, the signal light passes through a PIN diode area of the working part in the optical circuit 5A in the same traveling direction such that the signal light TE1 firstly passes and the signal light TE0 secondly passes, so that it is possible to reduce an influence of the reflected return light. In other words, it is possible to prevent a situation in which the reflected return light of the folded signal light TE0 affects the signal light TE0 that is input from the first waveguide 2. Further, it is possible to prevent a situation in which the reflected return light of the folded signal light TE1 affects the first signal light TE1 that passes through the optical circuit 5A.

Furthermore, the optical device 1H is configured such that the first mode conversion unit 8A, the optical circuit 5A, and the second mode conversion unit 9A are arranged parallel to one another, so that it is possible to reduce the size of the optical device 1H.

Moreover, the first folded rib waveguide 10A1 and the second folded rib waveguide 10B1 are rib waveguides, so that it is possible to maintain orthogonality of the modes between the first signal light TE0 and the second signal light TE1.

Meanwhile, as one example of the optical circuit 5 of the first to the ninth embodiments, an optical modulator, such as a direct-current (DC) modulator, or various kinds of circuits, such as a phase shifter, may be applied. However, for example, a variable optical attenuator (VOA) is applicable, and an embodiment of an optical device in which a PIN-type VOA is applied will be described below as a tenth embodiment.

### (j) Tenth Embodiment

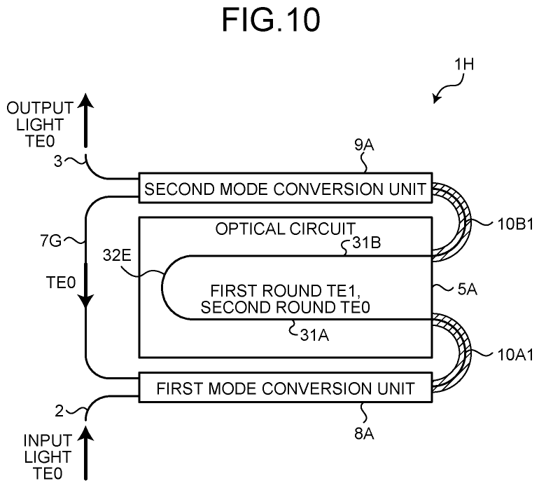

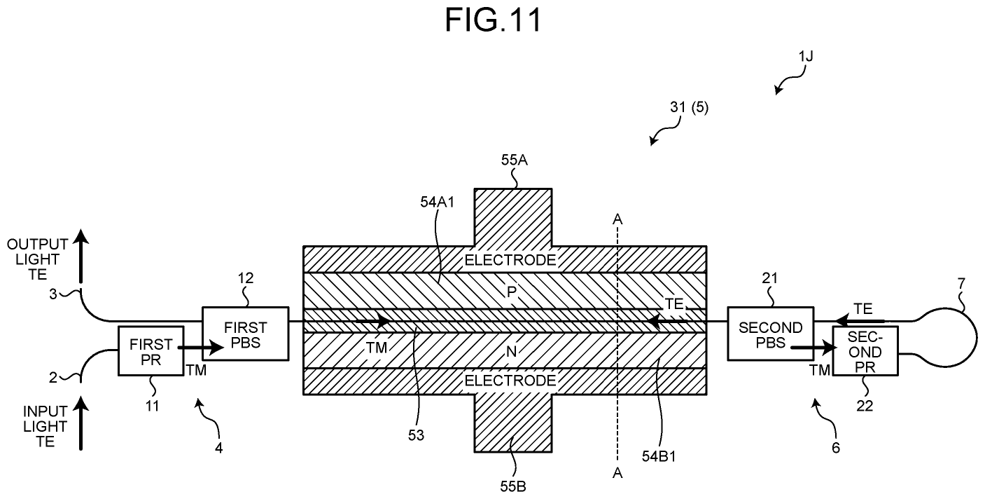

FIG. 11 is an explanatory diagram illustrating an example of an optical device 1J of the tenth embodiment, and FIG. 12 is a schematic cross-sectional view taken along a line A-A of the optical device 1J illustrated in FIG. 11. Meanwhile, the same components as those of the optical device 1 of the first embodiment will be denoted by the same reference symbols, and explanation of the same configurations and the same operation will be omitted.

The optical device 1J illustrated in FIG. 11 includes the first waveguide 2, the second waveguide 3, the first conversion unit 4, the optical circuit 5 that is a PIN-type VOA, the second conversion unit 6, and the folded waveguide 7. The first conversion unit 4 includes a first port that is connected to the first waveguide 2, a second port that is connected to the optical circuit 5, and a third port that is connected to the second waveguide 3. The first conversion unit 4 converts the signal light TE that travels from the first waveguide 2 into the signal light TM, and outputs the converted signal light TM to the optical circuit 5.

The second conversion unit 6 includes a fourth port that is connected to the optical circuit 5, a fifth port that is connected to one side of the folded waveguide 7, and a sixth port that is connected to another side of the folded waveguide 7. The second conversion unit 6 converts the signal light TE that travels from the optical circuit 5 and that is subjected to a light attenuation process into the signal light TM, and outputs the converted signal light TE to the optical circuit 5.

The first conversion unit 4 includes the first PR 11 and the first PBS 12. The first PR 11 includes a first port that is connected to the first waveguide 2 and a second port that is connected to the first PBS 12. The first PR 11 converts the signal light TE that travels from the first waveguide 2 into the signal light TM, and outputs the converted signal light TM to the first PBS 12. The first PBS 12 includes a first port that is connected to the first PR 11, a second port that is connected to the optical circuit 5, and a third port that is connected to the second waveguide 3. The first PBS 12 outputs the signal light TM that travels from the first PR 11 to the optical circuit 5A, and outputs the signal light TE that travels from the optical circuit 5A to the second waveguide 3.

The second conversion unit 6 includes the second PBS 21 and the second PR 22. The second PBS 21 includes a fourth port that is connected to the optical circuit 5, a fifth port that is connected to the second PR 22, and a sixth port that is connected to the folded waveguide 7. The second PBS 21 outputs the signal light TM that travels from the optical circuit 5 to the second PR 22, and outputs the signal light TE that travels from the folded waveguide 7 to the optical circuit 5. The second PR 22 includes a first port that is connected to the second PBS 21 and a second port that is connected to the folded waveguide 7, converts the signal light TM that travels from the second PBS 21 into the signal light TE, and outputs the converted signal light TE to the folded waveguide 7.

The optical circuit 5 illustrated in FIG. 12 includes an Si substrate 51, a cladding layer 52 that is laminated on the Si substrate 51 and that is made of SiO₂, and a rib waveguide 53 that is arranged inside the cladding layer 52 and that is made of Si. Further, the optical circuit 5 includes electrodes 55A and 55B that are arranged on a first slab 54A and a second slab 54B of the rib waveguide 53. The electrodes include a P electrode 55A and an N electrode 55B. Meanwhile, the working part 31 of the optical circuit 5 includes the rib waveguide 53, the P electrode 55A, and the N electrode 55B.

The rib waveguide 53 includes a P doped area 54A1 that is formed in a part of the first slab 54A that comes into contact with the P electrode 55A and an N doped area 54B1 that is formed in a part of the second slab 54B that comes into contact with the N electrode 55B. Meanwhile, a waveguide width of the rib waveguide 53 between the P doped area 54A1 and the N doped area 54B1 is denoted by W. If the waveguide width W is reduced, an absorption efficiency of the signal light is improved.

In the working part 31 in the optical circuit 5, if positive voltage is applied from the P electrode 55A to the N electrode 55B, electric current flows into the rib waveguide 53, and the signal light that is guided by the rib waveguide 53 is absorbed by free carrier absorption. As a result, in the optical circuit 5, intensity of the signal light that is guided by the rib waveguide 53 is attenuated.

The optical circuit 5 includes a first port that connects the first conversion unit 4 and the working part 31 and a second port that connects the second conversion unit 6 and the working part 31. The optical circuit 5 performs, in the working part 31, a light attenuation process on the converted signal light TM that travels from the first conversion unit 4, and outputs the signal light TM that is subjected to the light attenuation process to the second conversion unit 6.

The optical circuit 5 performs, in the working part 31, a light attenuation process on the converted signal light TE that travels from the second conversion unit 6, and outputs the signal light TE that is subjected to the light attenuation process to the first conversion unit 4. Further, the first conversion unit 4 outputs the signal light TE that travels from the optical circuit 5 to the second waveguide 3.

The optical circuit 5 performs light attenuation processes twice in total by performing the light attenuation process on the signal light TM that travels from the first conversion unit 4 to the second conversion unit 6 and performing the light attenuation process on the signal light TE that travels from the second conversion unit 6 to the first conversion unit 4. As a result, it is possible to double the functions of the VOA, reduce power consumption, and reduce a size of the optical device 1J.

Meanwhile, in the P doped area 54A1 and the N doped area 54B1 of the rib waveguide 53 in the optical circuit 5, resistance decreases with an increase in doping concentration, so that it is possible to reduce power consumption. However, with an increase in the doping concentration, light absorption in a state in which electric current does not flow increases, so that optical loss increases. Therefore, an embodiment of an optical device that is able to reduce an optical loss will be described below as an eleventh embodiment.

### (k) Eleventh Embodiment

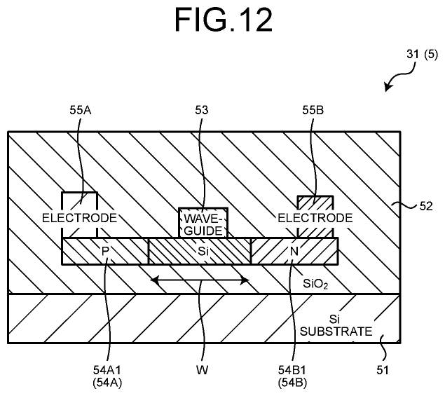

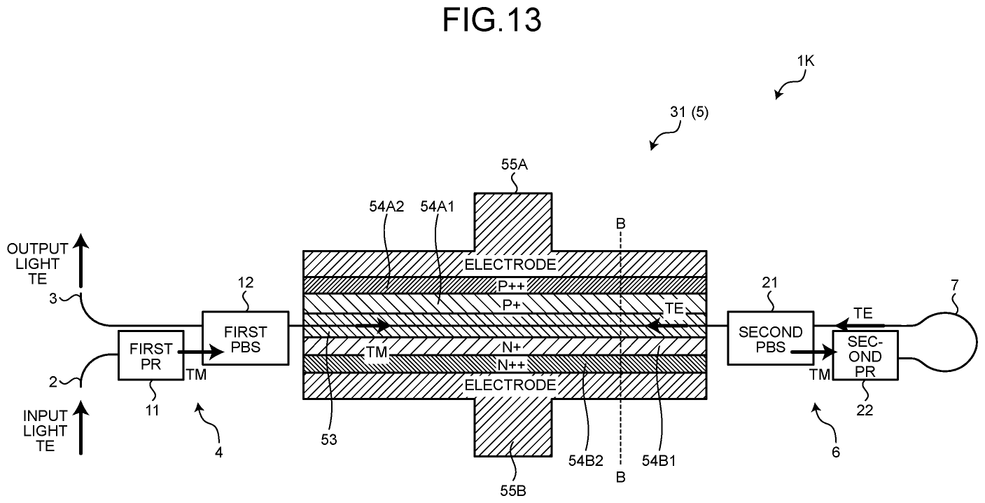

FIG. 13 is an explanatory diagram illustrating an example of an optical device 1K of the eleventh embodiment, and FIG. 14 is a schematic cross-sectional view taken along a line B-B of the optical device 1K illustrated in FIG. 13. Meanwhile, the same components as those of the optical device 1J of the tenth embodiment will be denoted by the same reference symbols, and explanation of the same configurations and the same operation will be omitted. The rib waveguide 53 in the optical circuit 5 illustrated in FIG. 13 and FIG. 14 includes the first slab 54A that comes into contact with the P electrode 55A and the second slab 54B that comes into contact with the N electrode 55B.

The first slab 54A includes a P+ doped area 54A1 that is located close to a rib of the rib waveguide 53 and a P++ doped area 54A2 that comes into contact with the P electrode 55A. The second slab 54B includes an N+ doped area 54B1 that is located close to the rib and an N++ doped area 54B2 that comes into contact with the N electrode 55B.

Doping concentration of each of the P++ doped area 54A2 and the N++ doped area 54B2 that are located close to the electrodes is increased as compared to doping concentration of each of the P+ doped area 54A1 and the N+ doped area 54B1.

The optical device 1K of the eleventh embodiment performs light attenuation processes twice in total by performing the light attenuation process on the signal light TM that travels from the first conversion unit 4 to the second conversion unit 6 and performing the light attenuation process on the signal light TE that travels from the second conversion unit 6 to the first conversion unit 4. As a result, it is possible to double the functions of the VOA, reduce power consumption, and reduce a size of the optical device 1K.

Further, the first slab 54A (the second slab 54B) of the rib waveguide 53 in the optical circuit 5 is configured such that the doping concentration of the area located close to the rib is reduced and the doping concentration of the area located close to the electrode 55A (55B) is increased. As a result, it is possible to prevent an optical loss, reduce the optical waveguide width W, and improve light absorption efficiency of the optical waveguide when electric current flows.

### (l) Twelfth Embodiment

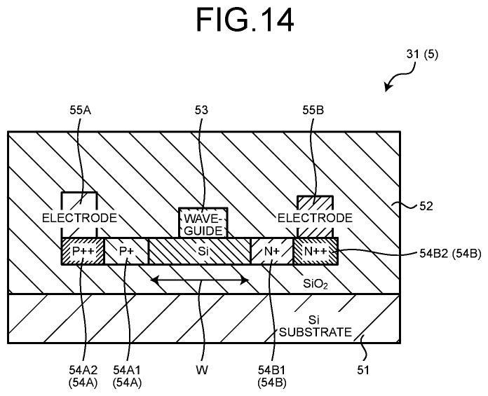

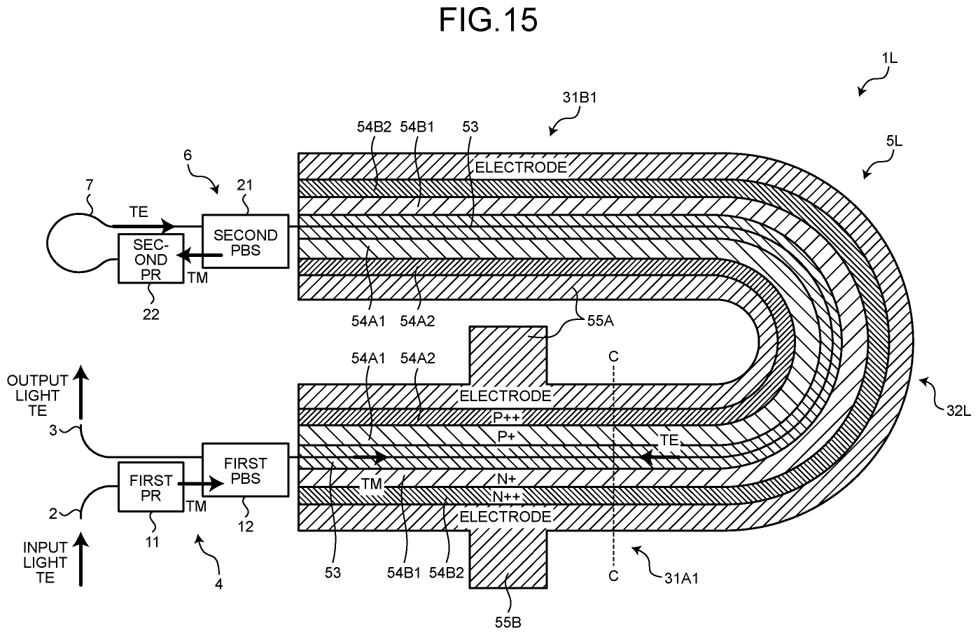

FIG. 15 is an explanatory diagram illustrating an example of an optical device 1L of a twelfth embodiment, and FIG. 16 is a schematic cross-sectional view taken along a line C-C of the optical device 1L illustrated in FIG. 15. The optical device 1L illustrated in FIG. 15 includes the first waveguide 2, the second waveguide 3, the first conversion unit 4, an optical circuit 5L, the second conversion unit 6, and the folded waveguide 7. The optical circuit 5L includes a forward-side working part 31A1, the backward-side working part 31B1, and a folded-side working part 32L that optically couples the forward-side working part 31A1 and the backward-side working part 31B1.

The first conversion unit 4 includes a first port that is connected to the first waveguide 2, a second port that is connected to the optical circuit 5L, and a third port that is connected to the second waveguide 3. The first conversion unit 4 converts the signal light TE that travels from the first waveguide 2 into the signal light TM, and outputs the converted signal light TM to the optical circuit 5L.

The optical circuit 5L includes a first port that connects the first conversion unit 4 and the forward-side working part 31A1 and a second port that connects the second conversion unit 6 and the backward-side working part 31B1. The optical circuit 5L performs a light attenuation process on the converted signal light TM that travels from the first conversion unit 4, and outputs the signal light TM that is subjected to the light attenuation process to the second conversion unit 6. The forward-side working part 31A1 performs, by an electric signal, a light attenuation process on the signal light TM that travels from the first conversion unit 4. The folded-side working part 32L performs, by an electric signal, a light attenuation process on the signal light TM that is subjected to the light attenuation process. Further, the backward-side working part 31B1 performs, by an electric signal, a light attenuation process on the signal light TM that is subjected to the light attenuation process and that travels from the folded-side working part 32L.

The second conversion unit 6 includes a fourth port that is connected to the backward-side working part 31B1 in the optical circuit 5L, a fifth port that is connected to one side of the folded waveguide 7, and a fifth port that is connected to another side of the folded waveguide 7. The second conversion unit 6 converts the signal light TM that travels from the optical circuit 5L and that is subjected to the optical processing into the signal light TE, and outputs the converted signal light TE to the backward-side working part 31B1 in the optical circuit 5L.

The optical circuit 5L performs a light attenuation process on the converted signal light TE that travels from the second conversion unit 6, and outputs the signal light TE that is subjected to the light attenuation process to the first conversion unit 4. Further, the first conversion unit 4 outputs the signal light TE that travels from the forward-side working part 31A1 in the optical circuit 5L to the second waveguide 3.

The first conversion unit 4 includes the first PR 11 and the first PBS 12. The first PR 11 includes a first port that is connected to the first waveguide 2 and a second port that is connected to the first PBS 12, converts the signal light TE that travels from the first waveguide 2 into the signal light TM, and outputs the converted signal light TM to the first PBS 12.

The first PBS 12 includes a first port that is connected to the first PR 11, a second port that is connected to the forward-side working part 31A1 in the optical circuit 5L, and a third port that is connected to the second waveguide 3. The first PBS 12 outputs the converted signal light TM that travels from the first PR 11 to the forward-side working part 31A1 in the optical circuit 5L, and outputs the signal light TE that travels from the forward-side working part 31A1 in the optical circuit 5L to the second waveguide 3.

The second conversion unit 6 includes the second PBS 21 and the second PR 22. The second PBS 21 includes a fourth port that is connected to the backward-side working part 31B1 in the optical circuit 5L, a fifth port that is connected to the second PR 22, and a sixth port that is connected to the folded waveguide 7. The second PBS 21 outputs the signal light TM that travels from the backward-side working part 31B1 in the optical circuit 5L to the second PR 22, and outputs the signal light TE that travels from the folded waveguide 7 to the backward-side working part 31B1 in the optical circuit 5L.

The second PR 22 includes a first port that is connected to the second PBS 21 and a second port that is connected to the folded waveguide 7, converts the signal light TM that travels from the second PBS 21 into the signal light TE, and outputs the converted signal light TE to the folded waveguide 7.

The optical circuit 5L includes the Si substrate 51, the cladding layer 52 that is laminated on the Si substrate 51 and that is made of SiO₂, the rib waveguide 53 that is laminated on the cladding layer 52 and that is made of Si, and electrodes that are arranged on both of the slabs 54A and 54B of the rib waveguide 53. The electrodes include the P electrode 55A and the N electrode 55B. Meanwhile, the forward-side working part 31A1 (32L and 31B1) of the optical circuit 5L includes the rib waveguide 53, the P electrode 55A, and the N electrode 55B.

The slabs of the rib waveguide 53 include the first slab 54A that comes into contact with the P electrode 55A and the second slab 54B that comes into contact with the N electrode 55B. The first slab 54A includes the P+ doped area 54A1 that is located close to the rib of the rib waveguide 53 and the P++ doped area 54A2 that comes into contact with the P electrode 55A The second slab 54B includes the N+ doped area 54B1 that is located close to the rib and the N++ doped area 54B2 that comes into contact with the N electrode 55B. Meanwhile, the doping concentration of each of the P+ doped area 54A1 and the N+ doped area 54B1 is reduced, and the doping concentration of each of the P++ doped area 54A2 and the N++ doped area 54B2 that are located close to the electrodes is increased.

The optical circuit 5L performs light attenuation processes twice in total by performing the light attenuation process on the signal light TM that travels from the first conversion unit 4 to the second conversion unit 6 and performing the light attenuation process on the signal light TE that travels from the second conversion unit 6 to the first conversion unit 4. As a result, it is possible to double the functions of the VOA, reduce power consumption, and reduce a size of the optical device 1L.

Further, the first slab 54A (the second slab 54B) of the rib waveguide 53 in the optical circuit 5L is configured such that the doping concentration of the area that is located close to the rib is reduced and the doping concentration of the area that is located close to the electrode is increased. As a result, it is possible to prevent an optical loss and reduce resistance.

Furthermore, the optical circuit 5L in the optical device 1L includes the folded-side working part 32L that optically couples the forward-side working part 31A1 and the backward-side working part 3181 with each other, so that it is possible to reduce the waveguide length of the VOA and reduce the size of the optical circuit 5L.

Meanwhile, the rib waveguide 53 of the optical circuit 5L in the optical device 1L of the twelfth embodiment is configured such that confinement of passing light is reduced and, in particular, if a curvature radius of the folded-side working part 32L is reduced, a bending loss is increased. Therefore, an embodiment of an optical device that copes with the situation as described above will be described below as a thirteenth embodiment.

### (m) Thirteenth Embodiment

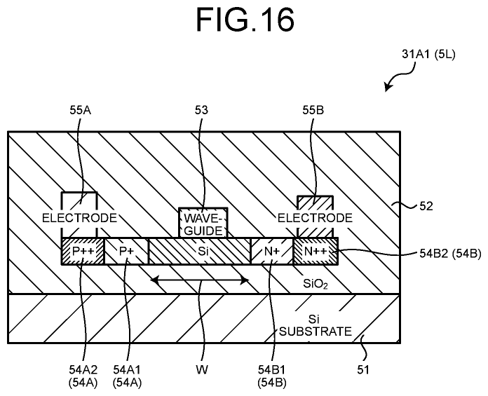

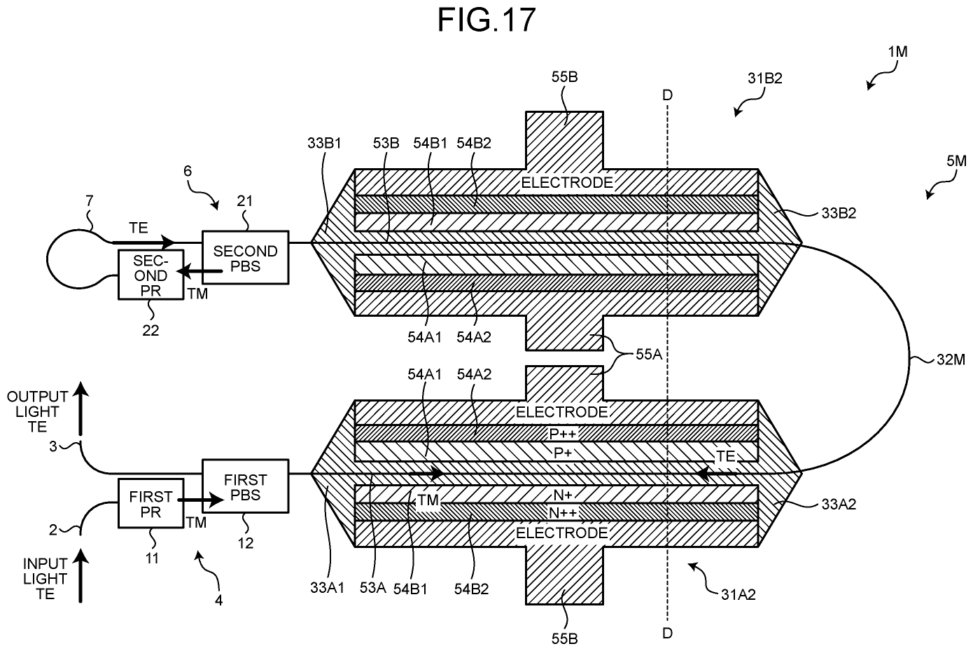

FIG. 17 is an explanatory diagram illustrating an example of an optical device 1M of the thirteenth embodiment, and FIG. 18 is a schematic cross-sectional view taken along a line D-D of the optical device 1M illustrated in FIG. 17. Meanwhile, the same components as those of the optical device 1M of the twelfth embodiment will be denoted by the same reference symbols, and explanation of the same configurations and the same operation will be omitted. The optical device 1M illustrated in FIG. 17 includes the first waveguide 2, the second waveguide 3, the first conversion unit 4, an optical circuit 5M, the second conversion unit 6, and the folded waveguide 7. The optical circuit 5M includes a forward-side working part 31A2 that is connected to the first PBS 12 in the first conversion unit 4 and a backward-side working part 31B2 that is connected to the second PBS 21 in the second conversion unit 6. Further, the optical circuit 5M includes a folded channel waveguide 32M that optically couples the forward-side working part 31A2 and the backward-side working part 31B2.

The forward-side working part 31A2 illustrated in FIG. 18 includes the forward-side first conversion waveguide 33A1, a forward-side rib waveguide 53A, the forward-side second conversion waveguide 33A2, the forward-side P electrode 55A, and the forward-side N electrode 55B. The slabs in the forward-side rib waveguide 53A include the forward-side first slab 54A including the P+ doped area 54A1 and the P++ doped area 54A2, and the forward-side second slab 54B including the N+ doped area 54B1 and the N++ doped area 54B2.

The forward-side first conversion waveguide 33A1 is a waveguide that connects the channel waveguide connected to the first PBS 12 and the forward-side rib waveguide 53A, and that has a tapered shape in which the slab width is gradually increased while transition from the channel waveguide to the rib waveguide. The forward-side second conversion waveguide 33A2 is a waveguide that connects the forward-side rib waveguide 53A and the folded channel waveguide 32M, and that has a tapered shape in which the slab width is gradually reduced while transition from the rib waveguide to the channel waveguide.

The backward-side working part 31B2 illustrated in FIG. 18 includes the backward-side first conversion waveguide 33B1, a backward-side rib waveguide 53B, the backward-side second conversion waveguide 33B2, the backward-side P electrode 55A, and the backward-side N electrode 55B. The slab in the backward-side rib waveguide 53B includes the backward-side first slab 54A including the P+ doped area 54A1 and the P++ doped area 54A2, and the backward-side second slab 54B including the N+ doped area 54B1 and the N++ doped area 54B2.

The backward-side first conversion waveguide 33B1 is a waveguide that connects the channel waveguide connected to the second PBS 21 and the backward-side rib waveguide 53B, and that has a tapered shape in which the slab width is gradually increased while transition from the channel waveguide to the rib waveguide. The backward-side second conversion waveguide 33B2 is a waveguide that connects the backward-side rib waveguide 53B and the folded channel waveguide 32M, and that has a tapered shape in which the slab width is gradually reduced while transition from the rib waveguide to the channel waveguide is a waveguide.

In the optical circuit 5M in the optical device 1M of the thirteenth embodiment, light attenuation processes are performed twice in total by performing the light attenuation process on the signal light TM that travels from the first conversion unit 4 to the second conversion unit 6 and performing the light attenuation process on the signal light TE that travels from the second conversion unit 6 to the first conversion unit 4. As a result, it is possible to double the functions of the VOA, reduce power consumption, and reduce a size of the optical device 1M.

In the optical device 1M, the forward-side working part 31A2 and the backward-side working part 31B2 are optically coupled with each other by the folded channel waveguide 32M. As a result, it is possible to increase optical confinement in the folded channel waveguide 32M, and, even if a curvature radius of the folded channel waveguide 32M is reduced, it is possible to return the signal light without increasing an optical loss at a bending radius.

In addition, the optical circuit 5M includes the forward-side first conversion waveguide 33A1 (33B1) and the forward-side second conversion waveguide 33A2 (33B2) that are waveguides that have tapered shapes in which the slab widths are gradually increased between the channel waveguide and the rib waveguide. As a result, it is possible to prevent an optical loss that occurs between the rib waveguide and the channel waveguide.

Meanwhile, in the optical circuit 5M of the thirteenth embodiment, the example has been described in which the P electrode 55A is arranged in each of the forward-side working part 31A2 and the backward-side working part 31B2, but the P electrode 55A may be shared and the number of terminals of the electrodes may be reduced; therefore, this embodiment will be described below as a fourteenth embodiment.

### (n) Fourteenth Embodiment

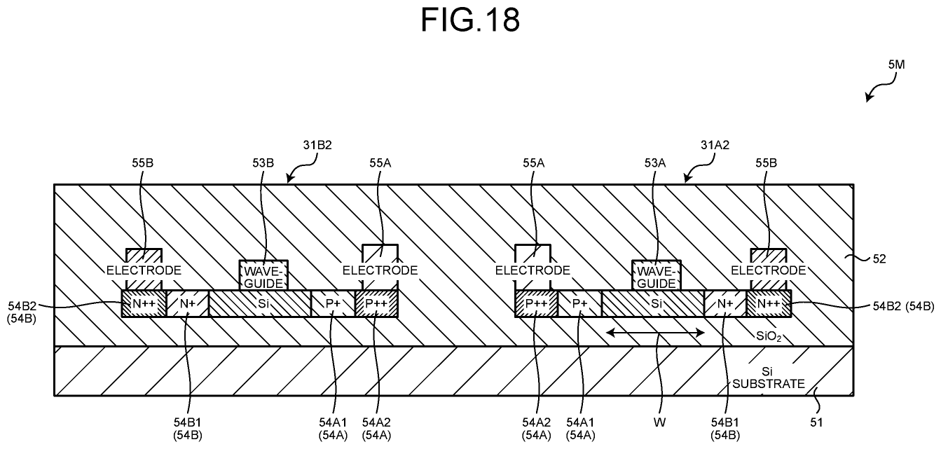

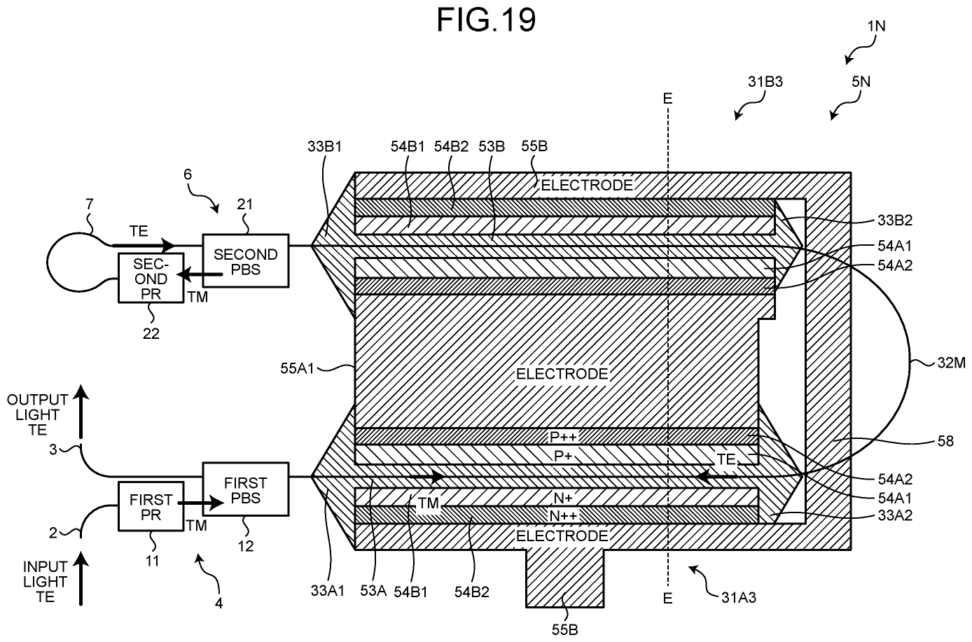

FIG. 19 is an explanatory diagram illustrating an example of an optical device 1N of the fourteenth embodiment, and FIG. 20 is a schematic cross-sectional view taken along a line E-E of the optical device 1N illustrated in FIG. 19. Meanwhile, the same components as those of the optical device 1M of the thirteenth embodiment will be denoted by the same reference symbols, and explanation of the same configurations and the same operation will be omitted.

The optical device 1N illustrated in FIG. 19 includes the first waveguide 2, the second waveguide 3, the first conversion unit 4, an optical circuit 5N, the second conversion unit 6, and the folded waveguide 7. The optical circuit 5N includes a forward-side working part 31A3, a backward-side working part 31B3, and the folded channel waveguide 32M. The forward-side working part 31A3 and the backward-side working part 3183 include the single P electrode 55A1 in which the forward-side P electrode 55A and the backward-side P electrode 55A are shared. Further, the forward-side working part 31A3 and the backward-side working part 31B3 include a connection portion 58 that electrically connects the forward-side N electrode 55B and the backward-side N electrode 55B.

The P electrode 55A illustrated in FIG. 20 electrically connects a via 57 that is electrically connected to the forward-side P++ doped area 54A2 in the forward-side working part 31A3 and the via 57 that is electrically connected to the backward-side P++ doped area 54A2 in the backward-side working part 31B3. The connection portion 58 electrically connects the forward-side N electrode 55B, which is connected to the via 57 that is connected to the forward-side N++ doped area 54B2 of the forward-side working part 31A3, and the backward-side N electrode 55B, which is connected to the via 57 that is connected to the N++ doped area 54B2 of the backward-side working part 31B3.

In the optical circuit 5N, if voltage is applied to the forward-side N electrode 55B and the backward-side N electrode 55B, electric current flows from the N electrode 55B to the P electrode 55A1 on the forward side and the signal light that is guided by the forward-side rib waveguide 53A in the forward-side working part 31A3 is absorbed. Further, in the optical circuit 5N, electric current flows from the N electrode 55B to the P electrode 55A1 on the backward side, and the signal light that is guided by the backward-side rib waveguide 53B in the backward-side working part 31B3 is absorbed.

In the optical device 1N of the fourteenth embodiment, light attenuation processes are performed twice in total by performing the light attenuation process on the signal light TM that travels from the first conversion unit 4 to the second conversion unit 6 and by performing the light attenuation process on the signal light TE that travels from the second conversion unit 6 to the first conversion unit 4. As a result, it is possible to double the functions of the VOA, reduce power consumption, and reduce a size of the optical device 1N.

In the optical circuit 5N, the P electrode 55A1 is shared between the forward-side working part 31A3 and the backward-side working part 31B3, and the terminal is arranged in the P electrode 55A1, so that it is possible to reduce the number of terminals on the electrode side as compared to the optical device 1M illustrated in FIG. 17. Further, in the optical circuit 5N, the connection portion 58 that electrically connects the forward-side N electrode 55B and the backward-side N electrode 55B is provided and the terminal is arranged in any of the N electrode 55B and the connection portion 58, so that it is possible to reduce the number of terminals on the N electrode side as compared to the optical device 1M illustrated in FIG. 17.

Meanwhile, in the optical circuit 5N in the optical device 1N of the fourteenth embodiment, the example has been described in which the P++ doped area 54A2 in the forward-side working part 31A3 and the P++ doped area 54A2 in the backward-side working part 31B3 are connected to each other by the single P electrode 55A1. However, the P++ doped area 54A2 in the forward-side working part 31A3 and the P++ doped area 54A2 in the backward-side working part 31B3 may be shared, and this embodiment will be described below as a fifteenth embodiment.

### (o) Fifteenth Embodiment

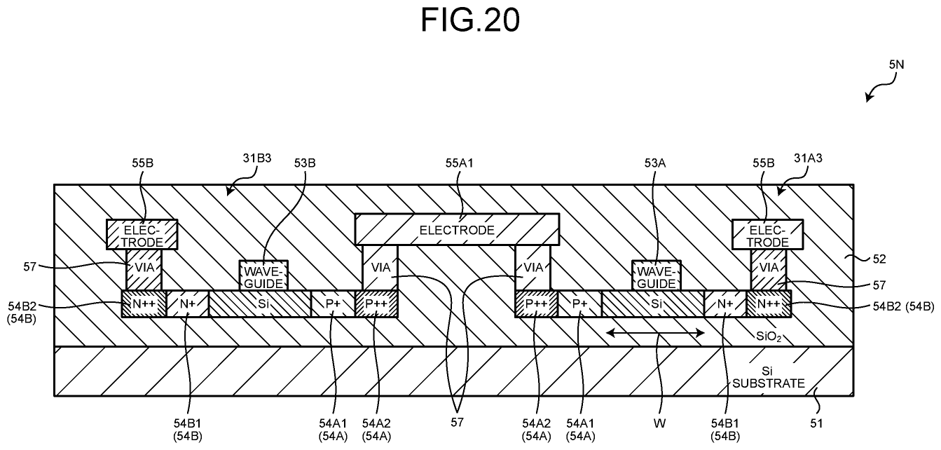

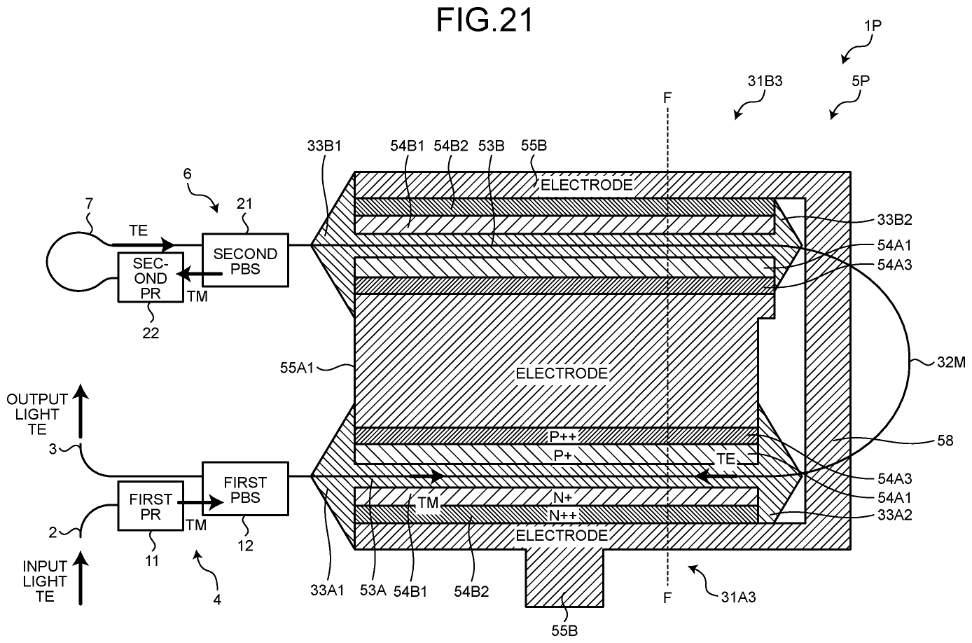

FIG. 21 is an explanatory diagram illustrating an example of an optical device 1P of the fifteenth embodiment, and FIG. 22 is a schematic cross-sectional view taken along a line F-F of the optical device 1P illustrated in FIG. 21. Meanwhile, the same components as those of the optical device 1N of the fourteenth embodiment will be denoted by the same reference symbols, and explanation of the same configurations and the same operation will be omitted.

The optical device 1P illustrated in FIG. 21 includes the first waveguide 2, the second waveguide 3, the first conversion unit 4, an optical circuit 5P, the second conversion unit 6, and the folded waveguide 7. The optical circuit 5P includes a single P++ doped area 54A3 that connects the P+ doped area 54A1 in the forward-side working part 31A3 and the backward-side P+ doped area 54A1. The P++ doped area 54A3 is electrically connected to the single P electrode 55A by a via.

The optical circuit 5P applies voltage to the N electrode 55B in the forward-side working part 31A3 and the N electrode 55B in the backward-side working part 31B3. As a result, in the optical circuit 5P, electric current flows from the N electrode 55B to the P electrode 55A1 on the forward side, and the signal light that is guided by the forward-side rib waveguide 53A in the forward-side working part 31A3 is absorbed. Further, in the optical circuit 5P, electric current flows from the N electrode 55B to the P electrode 55A1 on the backward side, and the signal light that is guided by the backward-side rib waveguide 53B in the backward-side working part 31B3 is absorbed.

In the optical device 1P of the fifteenth embodiment, light attenuation processes are performed twice in total by performing the light attenuation process on the signal light TM that travels from the first conversion unit 4 to the second conversion unit 6 and performing the light attenuation process on the signal light TE that travels from the second conversion unit 6 to the first conversion unit 4. As a result, it is possible to double the functions of the VOA, reduce power consumption, and reduce a size of the optical device 1P.

In the optical circuit 5P, the P++ doped area 54A3 for the forward-side working part 31A3 and the backward-side working part 31B3 is shared, so that it is possible to decrease an interval between the forward-side working part 31A3 and the backward-side working part 3183.

Meanwhile, in the optical device 1P of the fifteenth embodiment, the first signal light TM and the second signal light TE travel in opposite directions in the forward-side working part 31A3 and the backward-side working part 31B3 in the optical circuit 5P. Therefore, for example, due to incompleteness of the first PBS 12 and the first PR 11, the folded signal light TE travels through the first waveguide 2 in the opposite direction. As a result, the reflected return light of the folded signal light TE affects the signal light TE that is input from the first waveguide 2. Further, for example, due to incompleteness of the second PBS 21 and the second PR 22, the folded signal light TM travels through the first PR 11 in the opposite direction. As a result, the reflected return light of the folded signal light TM affects the first signal light TM that passes through the optical circuit 5P. Therefore, an embodiment that is able to prevent the reflected return light as described above will be described below as a sixteenth embodiment.

### (p) Sixteenth Embodiment

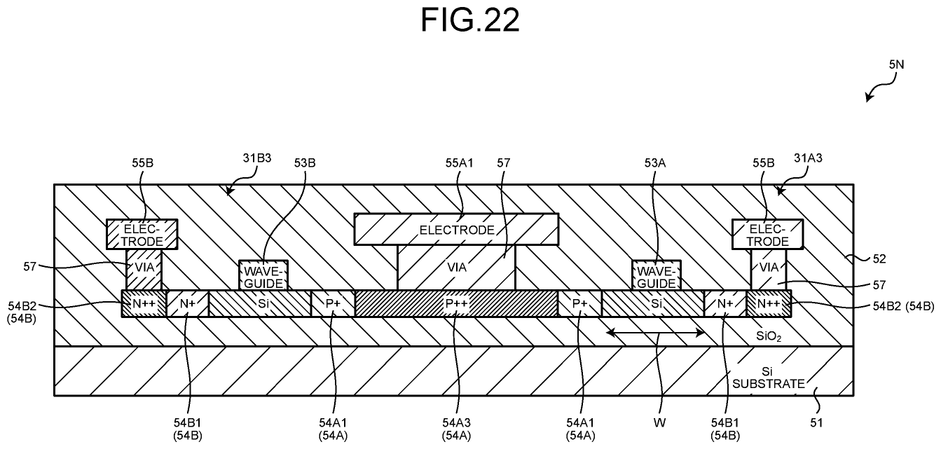

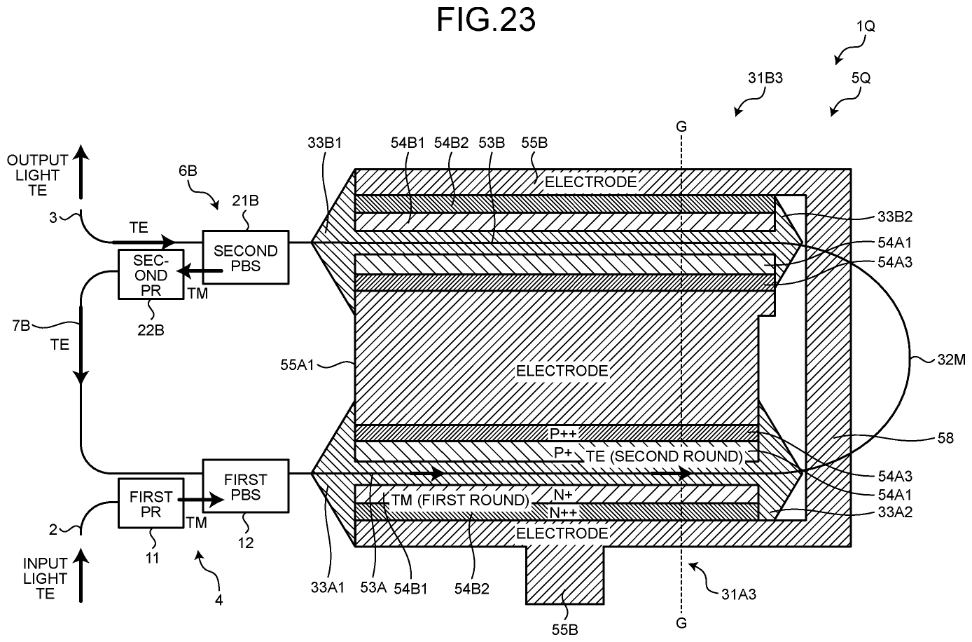

FIG. 23 is an explanatory diagram illustrating an example of an optical device 1Q of the sixteenth embodiment, and FIG. 24 is a schematic cross-sectional view taken along a line G-G of the optical device 1Q illustrated in FIG. 23. Meanwhile, the same components as those of the optical device 1P of the fifteenth embodiment will be denoted by the same reference symbols, and explanation of the same configurations and the same operation will be omitted. The optical device 1Q illustrated in FIG. 23 includes the first waveguide 2, the second waveguide 3, the first conversion unit 4, an optical circuit 5Q, the second conversion unit 6B, and the folded waveguide 7B. The optical circuit 5Q includes the forward-side working part 31A3, the backward-side working part 31B3, and the folded channel waveguide 32M that optically couples the forward-side working part 31A3 and the backward-side working part 31B3 with each other.

The first conversion unit 4 includes a first port that is connected to the first waveguide 2, a second port that is connected to the forward-side working part 31A3 in the optical circuit 5Q, and a third port that is connected to the folded waveguide 7B. The first conversion unit 4 converts the signal light TE that travels from the first waveguide 2 into the signal light TM, and outputs the converted signal light TM to the forward-side working part 31A3 in the optical circuit 5Q.

The optical circuit 5Q includes a first port that connects the first conversion unit 4 and the forward-side working part 31A3, and a second port that connects the second conversion unit 6B and the backward-side working part 31B3. The optical circuit 5Q performs a light attenuation process the converted signal light TM that travels from the first conversion unit 4, and outputs the signal light TM that is subjected to the light attenuation process to the second conversion unit 6. Meanwhile, the optical circuit 5Q has the same configuration as the optical circuit of the fifteenth embodiment.

The second conversion unit 6B includes a fourth port that is connected to the backward-side working part 31B3 in the optical circuit 5Q, a fifth port that is connected to the folded waveguide 78, and a sixth port that is connected to the second waveguide 3. The second conversion unit 6B converts the signal light TM that travels from the backward-side working part 31B3 in the optical circuit 5Q and that is subjected to the light attenuation process into the signal light TE, and outputs the converted signal light TE to the forward-side working part 31A3 in the optical circuit 5Q via the folded waveguide 7B and the first conversion unit 4.

The optical circuit 5Q performs a light attenuation process on the converted signal light TE that travels from the second conversion unit 6B, and outputs the signal light TE that is subjected to the light attenuation process to the second conversion unit 6B. Further, the second conversion unit 6B outputs the signal light TE that travels from the backward-side working part 31B3 in the optical circuit 5Q to the second waveguide 3.

The first conversion unit 4 includes the first PR 11 and the first PBS 12. The first PR 11 includes a first port that is connected to the first waveguide 2 and a second port that is connected to the first PBS 12, converts the signal light TE that travels from the first waveguide 2 into the signal light TM, and outputs the converted signal light TM to the first PBS 12.

The first PBS 12 includes a first port that is connected to the first PR 11, a second port that is connected to the forward-side working part 31A3 in the optical circuit 5Q, and a third port that is connected to the folded waveguide 7B. The first PBS 12 outputs the signal light TM that travels from the first PR 11 to the forward-side working part 31A3 in the optical circuit 5Q, and outputs the signal light TE that travels from the folded waveguide 7B to the forward-side working part 31A3 in the optical circuit 5Q.

The second conversion unit 6B includes the second PBS 21B and the second PR 22B. The second PBS 21B includes a fourth port that is connected to the backward-side working part 31B3 in the optical circuit 5Q, a fifth port that is connected to the second PR 22B, and a sixth port that is connected to the second waveguide 3. The second conversion unit 6B outputs the signal light TM that travels from the backward-side working part 31B3 in the optical circuit 5Q to the second PR 22B, and outputs the signal light TE that travels from backward-side working part 31B3 in the optical circuit 5Q to the second waveguide 3.

The second PR 22B includes a first port that is connected to the second PBS 21B and a second port that is connected to the folded waveguide 7B, converts the signal light TM that travels from the second PBS 21B into the signal light TE, and outputs the converted signal light TE to the folded waveguide 7B.

The optical circuit 5Q performs light attenuation processes twice in total in the same traveling direction by performing the light attenuation process on the signal light TM that travels from the first conversion unit 4 and performing the light attenuation process on the signal light TE that travels from the second conversion unit 6B via the first conversion unit 4. As a result, it is possible to double the functions of the VOA, reduce power consumption, and reduce a size of the optical device 1Q, and reduce an influence of the reflected return light.

In the optical device 1Q of the sixteenth embodiment, the second PR 22B on the posterior stage of the optical circuit 5Q is connected to the first PBS 12 on the prior stage of the optical circuit 5Q. As a result, the signal light passes through a PIN diode area of the forward-side working part 31A3 (31B3) in the optical circuit 5Q in the same traveling direction such that the signal light TM firstly passes and the signal light TE secondly passes, so that it is possible to reduce an influence of the reflected return light. In other words, it is possible to prevent a situation in which the reflected return light of the folded signal light TE affects the signal light TE that is input from the first waveguide 2. Further, it is possible to prevent a situation in which the reflected return light of the folded signal light TM affects the first signal light TM that passes through the optical circuit 5Q.

Meanwhile, in the optical circuit 5Q of the optical device 1Q of the sixteenth embodiment, the example has been described in which the first conversion unit 4 converts the signal light TE into the signal light TM, and the second conversion unit 6B converts the signal light TM into the signal light TE, that is, the light is converted into orthogonally polarized waves. However, embodiments are not limited to this example, and the technology is applicable to a case in which the light is converted to an orthogonal higher-order mode. Therefore, this embodiment will be described below as a seventeenth embodiment.

### (q) Seventeenth Embodiment

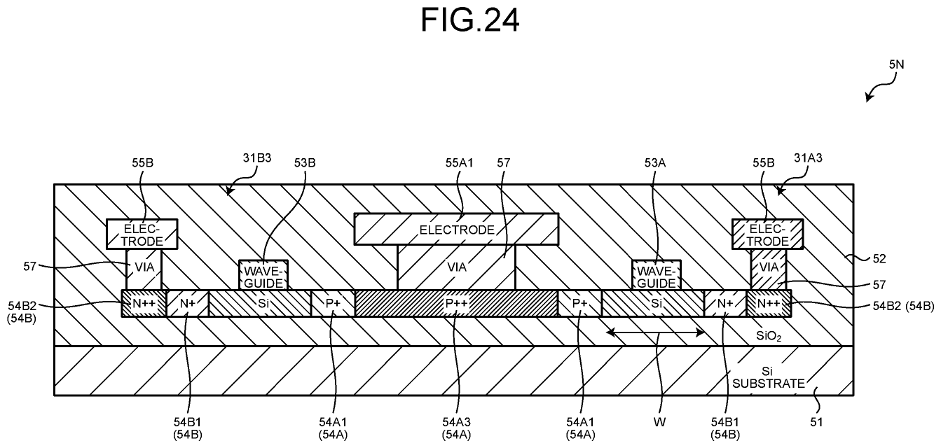

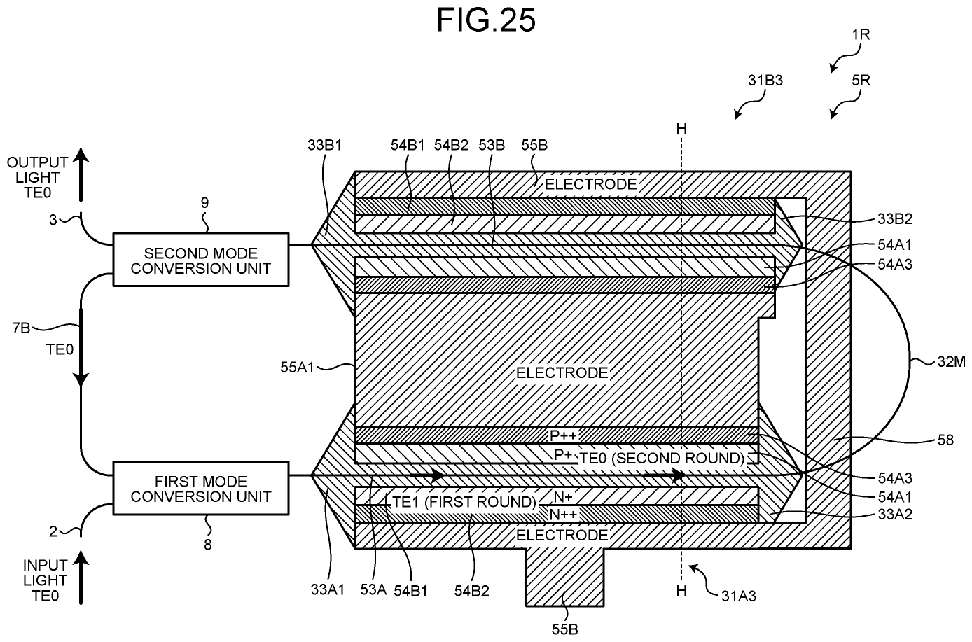

FIG. 25 is an explanatory diagram illustrating an example of an optical device 1R of the seventeenth embodiment, and FIG. 26 is a schematic cross-sectional view taken along a line H-H of the optical device 1R illustrated in FIG. 25. Meanwhile, the same components as those of the optical device 1P of the fifteenth embodiment will be denoted by the same reference symbols, and explanation of the same configurations and the same operation will be omitted. The optical device 1R illustrated in FIG. 25 includes the first waveguide 2, the second waveguide 3, the first mode conversion unit 8, an optical circuit 5R, the second mode conversion unit 9, and the folded waveguide 7B. The optical circuit 5R has the same configuration as the optical circuit illustrated in FIG. 15.

The first mode conversion unit 8 includes a first port that is connected to the first waveguide 2, a second port that is connected to the forward-side working part 31A3 in the optical circuit 5R, and a third port that is connected to the folded waveguide 7B. The first mode conversion unit 8 performs mode conversion on the signal light TE0 that travels from the first waveguide 2 to obtain the signal light TE1, and outputs the mode-converted signal light TE1 to the forward-side working part 31A3 in the optical circuit 5R. The first mode conversion unit 8 outputs the signal light TE0 that travels from the folded waveguide 7B to the forward-side working part 31A3 in the optical circuit 5R.

The optical circuit 5R includes a first port that connects the first mode conversion unit 8 and the forward-side working part 31A3, and a second port that connects the second mode conversion unit 9 and the backward-side working part 31B3. The optical circuit 5R performs a light attenuation process on the first converted signal light TE1 that travels from the first mode conversion unit 8, and outputs the signal light TE1 that is subjected to the light attenuation process to the second mode conversion unit 9. Further, the optical circuit 5R performs a light attenuation process on the second signal light TE0 that travels from the second mode conversion unit 9 via the first mode conversion unit 8, and outputs the signal light TE0 that is subjected to the light attenuation process to the second mode conversion unit 9.

The second mode conversion unit 9 includes a fourth port that is connected to the backward-side working part 31B3 in the optical circuit 5R, a fifth port that is connected to the folded waveguide 7B, and a sixth port that is connected to the second waveguide 3. The second mode conversion unit 9 performs mode conversion on the first signal light TE1 that travels from the forward-side working part 31A3 in the optical circuit 5R and that is subjected to the light attenuation process, and obtains the signal light TE0. The second mode conversion unit 9 outputs the converted signal light TE0 to the first mode conversion unit 8 via the folded waveguide 7B. The second mode conversion unit 9 outputs the second the signal light TE0 that travels from the optical circuit 5R and that is subjected to the light attenuation process to the second waveguide 3.

In other words, the optical circuit 5R performs light attenuation processes twice in total in the same direction by performing the light attenuation process on the first signal light TE1 that travels from the first mode conversion unit 8 and performing the light attenuation process on the second signal light TE0 that travels from the second mode conversion unit 9 via the first mode conversion unit 8. As a result, even in the higher-order mode, it is possible to double the functions of the VOA, reduce power consumption, reduce a size of the optical device 1R, and reduce an influence of the reflected return light.

In the optical device 1R of the seventeenth embodiment, the second mode conversion unit 9 on the posterior stage of the optical circuit 5R is connected to the first mode conversion unit 8 on the prior stage of the optical circuit 5R. As a result, the signal light passes through a PIN diode area of the forward-side working part 31A3 (31B3) in the same traveling direction such that the signal light TM firstly passes and the signal light TE secondly passes, so that it is possible to reduce an influence of the reflected return light. In other words, it is possible to prevent a situation in which the reflected return light of the folded signal light TE0 affects the signal light TE0 that is input from the first waveguide 2. Further, it is possible to prevent a situation in which the reflected return light of the folded signal light TE1 affects the first signal light TE1 that passes through the optical circuit 5R.

### (r) Eighteenth Embodiment

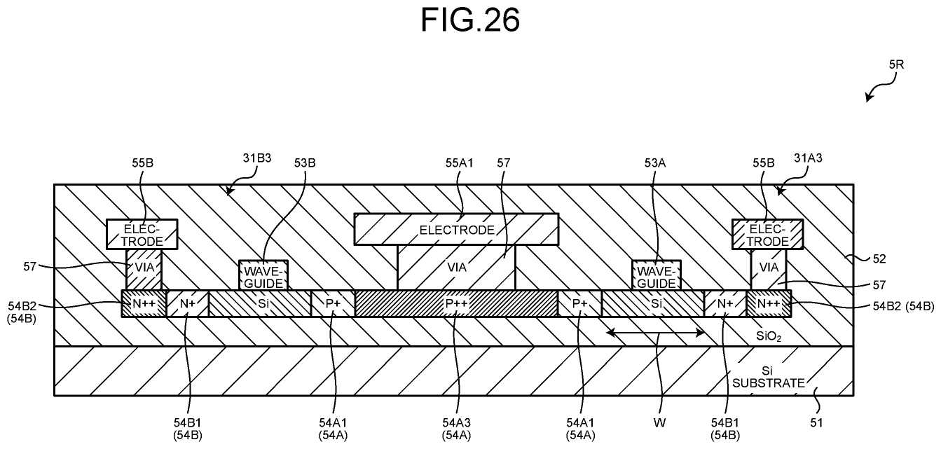

An embodiment that prevents reflected return light will be described below as an eighteenth embodiment. FIG. 27 is an explanatory diagram illustrating an example of an optical device 1S of the eighteenth embodiment. Meanwhile, the same components as those of the optical device 1P of the fifteenth embodiment will be denoted by the same reference symbols, and explanation of the same configurations and the same operation will be omitted.

The optical device 1S illustrated in FIG. 27 includes the first waveguide 2, the second waveguide 3, a first conversion unit 4S, the first folded channel waveguide 10A, an optical circuit 5S, the second folded channel waveguide 10B, a second conversion unit 6S, and a folded waveguide 7G. The optical circuit 5S includes a forward-side working part 31A4, a backward-side working part 31B4, and the folded channel waveguide 32M that optically couples the forward-side working part 31A4 and the backward-side working part 31B4 with each other.

The first conversion unit 4S includes a first port that is connected to the first waveguide 2, a second port that is connected to the first folded channel waveguide 10A, and a third port that is connected to the folded waveguide 7G. The first conversion unit 4S converts the signal light TE that travels from the first waveguide 2 into the signal light TM, and outputs the converted signal light TM to the first folded channel waveguide 10A. The first folded channel waveguide 10A is connected to the forward-side working part 31A4 in the optical circuit 5S. The forward-side working part 31A4 includes the forward-side first conversion waveguide 33A1 that optically couples the first folded channel waveguide 10A and the forward-side rib waveguide 53A with each other, and the forward-side second conversion waveguide 33A2 that optically couples the forward-side rib waveguide 53A and the folded channel waveguide 32M with each other.

The optical circuit 5S includes a first port that connects the first folded channel waveguide 10A and the forward-side working part 31A4, and a second port that connects the second folded channel waveguide 10B and the backward-side working part 31B4. The optical circuit 5S performs a light attenuation process on the converted signal light TM that travels from the first conversion unit 4S, and outputs the signal light TM that is subjected to the light attenuation process to the second conversion unit 6S. The backward-side working part 31B4 includes the backward-side first conversion waveguide 33B1 that optically couples the second folded channel waveguide 10B and the backward-side rib waveguide 53B with each other, and the backward-side second conversion waveguide 33B2 that optically couples the backward-side rib waveguide 53B and the folded channel waveguide 32M with each other.

The second conversion unit 6S includes a fourth port that is connected to the second folded channel waveguide 10B, a fifth port that is connected to the folded waveguide 7G, and a sixth port that is connected to the second waveguide 3. The second conversion unit 6S converts the signal light TM that travels from the second folded channel waveguide 10B and that is subjected to the light attenuation process into the signal light TE, and outputs the converted signal light TE to the first folded channel waveguide 10A via the folded waveguide 7G and the first conversion unit 4S. The second folded channel waveguide 10B is connected to the forward-side working part 31A4 in the optical circuit 5S.

The optical circuit 5S performs a light attenuation process on the signal light TE that travels from the first conversion unit 4S and that is converted by the second conversion unit 6S, and outputs the signal light TE that is subjected to the light attenuation process to the second conversion unit 6S. Further, the second conversion unit 6S outputs the signal light TE that travels from the backward-side working part 31B4 in the optical circuit 5S to the second waveguide 3.

The first conversion unit 4S includes the first PR 11 and the first PBS 12. The first PR 11 includes a first port that is connected to the first waveguide 2 and a second port that is connected to the first PBS 12. The first PR 11 converts the signal light TE that travels from the first waveguide 2 into the signal light TM, and outputs the converted signal light TM to the first PBS 12.

The first PBS 12 includes a first port that is connected to the first PR 11, a second port that is connected to the first folded channel waveguide 10A, and a third port that is connected to the folded waveguide 7G. The first PBS 12 outputs the signal light TM that travels from the first PR 11 to the first folded channel waveguide 10A, and outputs the signal light TE that travels from the folded waveguide 7G to the first folded channel waveguide 10A.

The second conversion unit 6S includes the second PBS 21G and the second PR 22G. The second PBS 21G includes a fourth port that is connected to the second folded channel waveguide 10B, a fifth port that is connected to the second PR 22G, and a sixth port that is connected to the second waveguide 3. The second PBS 21G outputs the signal light TM that travels from the second folded channel waveguide 10B to the second PR 22G, and outputs the signal light TE that travels from the second folded channel waveguide 10B to the second waveguide 3.

The second PR 22G includes a first port that is connected to the second PBS 21G and a second port that is connected to the folded waveguide 7G, converts the signal light TM that travels from the second PBS 21G into the signal light TE, and outputs the converted signal light TE to the folded waveguide 7G.

The optical circuit 5S performs light attenuation processes twice in total in the same direction by performing the light attenuation process on the first signal light TM that travels from the first folded channel waveguide 10A and performing the light attenuation process on the second signal light TE that travels from the first folded channel waveguide 10A. As a result, it is possible to double the functions of the VOA, reduce power consumption, reduce a size of the optical device 1S, and reduce an influence of the reflected return light.

In the optical device 1S of the eighteenth embodiment, the second PR 22G on the posterior stage of the optical circuit 5S is connected to the first PBS 12 on the prior stage of the optical circuit 5S. As a result, the signal light passes through a PIN diode area of the forward-side working part 31A4 (31B4) in the optical circuit 5S in the same traveling direction such that the signal light TM firstly passes and the signal light TE secondly passes, so that it is possible to reduce an influence of the reflected return light. In other words, it is possible to prevent a situation in which the reflected return light of the folded signal light TE affects the signal light TE that is input from the first waveguide 2. Further, it is possible to prevent a situation in which the reflected return light of the folded signal light TM affects the first signal light TM that passes through the optical circuit 5Q.

Furthermore, the optical device 1S is configured such that the first conversion unit 4S, the optical circuit 5S, and the second conversion unit 6S are arranged parallel to one another, so that it is possible to reduce the size of the optical device 1S.

### (r) Nineteenth Embodiment

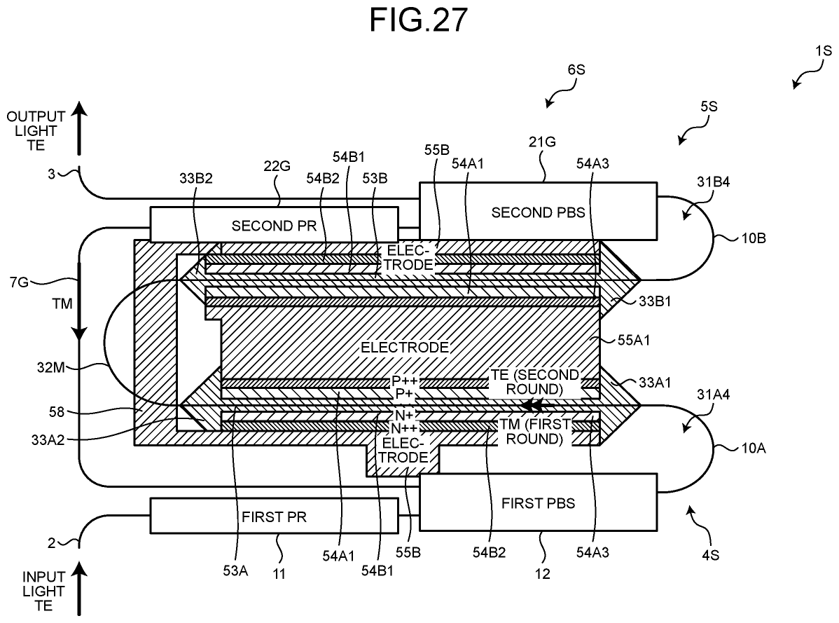

An embodiment that prevents reflected return light will be described below as a nineteenth embodiment. FIG. 28 is an explanatory diagram illustrating an example of an optical device 1T of the nineteenth embodiment. Meanwhile, the same components as those of the optical device 1P of the fifteenth embodiment will be denoted by the same reference symbols, and explanation of the same configurations and the same operation will be omitted.

The optical device 1T illustrated in FIG. 28 includes the first waveguide 2, the second waveguide 3, a first mode conversion unit 8T, the first folded rib waveguide 10A1, an optical circuit 5T, the second folded rib waveguide 10B1, a second mode conversion unit 9T, and the folded waveguide 7G. The optical circuit 5T includes the forward-side working part 31A4, the backward-side working part 31B4, and the folded channel waveguide 32M that optically couples the forward-side working part 31A4 and the backward-side working part 31B4 with each other.

The first mode conversion unit 8T includes a first port that is connected to the first waveguide 2, a second port that is connected to the first folded rib waveguide 10A1, and a third port that is connected to the folded waveguide 7G. The first mode conversion unit 8T performs higher-mode conversion on the signal light TE0 that travels from the first waveguide 2 and obtains the signal light TE1. The first mode conversion unit 8T outputs the converted signal light TE1 to the first folded rib waveguide 10A1. The first folded rib waveguide 10A1 is connected to the forward-side working part 31A4 in the optical circuit 5T. The forward-side working part 31A4 includes the forward-side first conversion waveguide 33A1 that optically couples the first folded rib waveguide 10A1 and the forward-side rib waveguide 53A with each other, and the forward-side second conversion waveguide 33A2 that optically couples the forward-side rib waveguide 53A and the folded channel waveguide 32M with each other.

The optical circuit 5T includes a first port that connects the first folded rib waveguide 10A1 and the forward-side working part 31A4, and a second port that connects the second folded rib waveguide 10B1 and the backward-side working part 31B4. The optical circuit 5T performs a light attenuation process on the converted signal light TE1 that travels from the first mode conversion unit 8T, and outputs the signal light TE that is subjected to the light attenuation process 1 to the second mode conversion unit 9T. The backward-side working part 31A4 includes the backward-side first conversion waveguide 33B1 that optically couples the second folded rib waveguide 10B1 and the backward-side rib waveguide 53B with each other. The backward-side working part 31A4 includes the backward-side second conversion waveguide 33B2 that optically couples the backward-side rib waveguide 53B and the folded channel waveguide 32M with each other.

The second mode conversion unit 9T includes a fourth port that is connected to the second folded rib waveguide 10B1, a fifth port that is connected to the folded waveguide 7G, and a sixth port that is connected to the second waveguide 3. The second mode conversion unit 9T converts the signal light TE1 that travels from the second folded rib waveguide 10B1 and that is subjected to the light attenuation process into the signal light TE0, and outputs the converted signal light TE0 to the first folded rib waveguide 10A1 via the folded waveguide 7G and the first mode conversion unit 8T. The second folded rib waveguide 10B1 is connected to the forward-side working part 31A4 in the optical circuit 5T.

The optical circuit 5T performs a light attenuation process on the signal light TE0 that travels from the first mode conversion unit 8T and that is converted by the second mode conversion unit 9T, and outputs the signal light TE0 that is subjected to the light attenuation process to the second mode conversion unit 9T. Further, the second mode conversion unit 9T outputs the second signal light TE0 that travels from the second folded rib waveguide 10B1 to the second waveguide 3.

The optical circuit 5T performs light attenuation processes twice in total in the same direction by performing the light attenuation process on the first signal light TE1 that travels from the first folded rib waveguide 10A1 and performing the light attenuation process on the second signal light TE0 that travels from the first folded rib waveguide 10A1. As a result, it is possible to double the functions of the VOA, reduce power consumption, reduce a size of the optical device 1T, and reduce an influence of the reflected return light.

In the optical device 1T of the nineteenth embodiment, the second mode conversion unit 9T on the posterior stage of the optical circuit 5T is connected to the first mode conversion unit 8T on the prior stage of the optical circuit 5T. As a result, the signal light passes through a PIN diode area of the forward-side working part 31A4 (31B4) in the optical circuit 5T in the same traveling direction such that the signal light TE1 firstly passes and the signal light TE0 secondly passes, so that it is possible to reduce an influence of the reflected return light. In other words, it is possible to prevent a situation in which the reflected return light of the folded signal light TEC affects the signal light TE0 that is input from the first waveguide 2. Further, it is possible to prevent a situation in which the reflected return light of the folded signal light TE1 affects the first signal light TE1 that passes through the optical circuit 5T.

Furthermore, the optical device 1T is configured such that the first mode conversion unit 8T, the optical circuit 5T, and the second mode conversion unit 9T are arranged parallel to each other, so that it is possible to reduce the size of the optical device 1T.

Meanwhile, in the optical device 1 of the first embodiment, it may be possible to replace the first conversion unit 4 with the first mode conversion unit 8 and replace the second conversion unit 6 with the second mode conversion unit 9, and an appropriate modification is applicable.

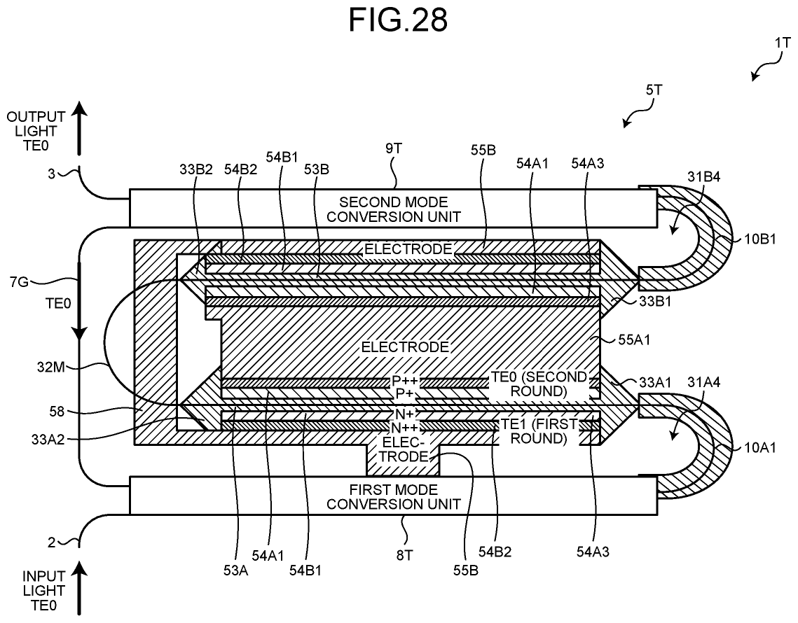

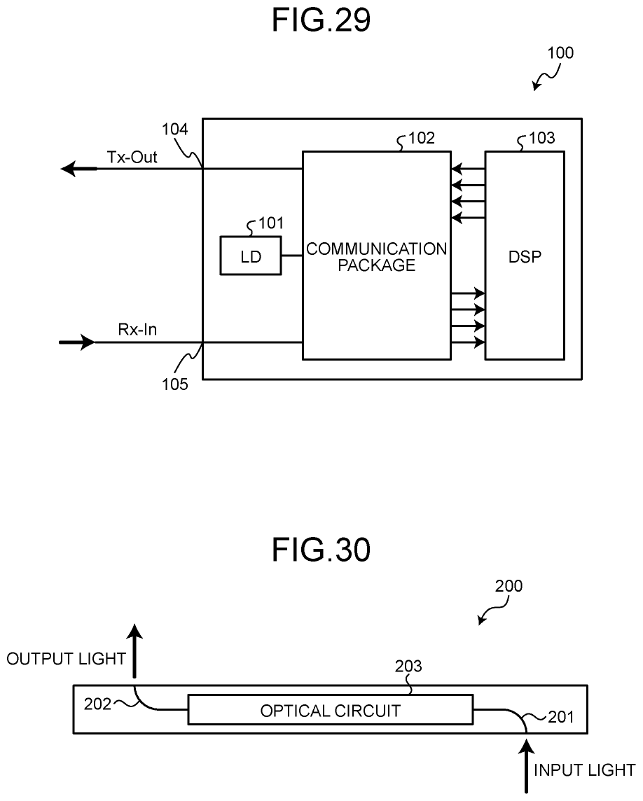

FIG. 29 is an explanatory diagram illustrating an example of an optical communication apparatus 100. The optical communication apparatus 100 illustrated in FIG. 29 is an optical coherent transceiver that is connected to an output-side optical fiber 104 and an input-side optical fiber 105 that are optical fibers, for example. The optical communication apparatus 100 includes a laser diode (LD) 101, a communication package 102, and a digital signal processor (DSP) 103. The communication package 102 is, for example, the optical device 1 illustrated in FIG. 1.

The DSP 103 is an electric component that performs digital signal processing. The DSP 103 performs, for example, certain processing, such as encoding, on transmission data, and outputs a data signal corresponding to the transmission data subjected to the processing to a transmission circuit in the communication package 102. Further, the DSP 103 performs certain processing, such as decoding, on reception data corresponding to a data signal that is obtained from a reception circuit in the communication package 102.

The LD 101 is, for example, an integrated tunable laser assembly (ITLA) that includes a wavelength tunable laser diode, generates light with a predetermined wavelength, and supplies the light to an optical modulator in the transmission circuit and an optical received in the reception circuit.

Meanwhile, for convenience of explanation, the example has been described in which the optical device 1 includes, inside thereof, both of the transmission circuit and the reception circuit, but the optical device 1 may include, inside thereof, only one of the transmission circuit and the reception circuit. The optical device functions as an optical transmitter when including only the transmission circuit and functions as an optical receiver when including only the reception circuit.

According to one aspect, an optical device or the like that is able to reduce the size and power consumption by reducing a working length of an optical circuit.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An optical device comprises:
a first waveguide that inputs first signal light with a first optical characteristic;
a first convertor that is connected to the first waveguide and converts the first signal light that travels from the first waveguide into second signal light with a second optical characteristic;
an optical circuit that is connected to the first convertor, and when the converted second signal light from the first convertor passes through the optical circuit, performs first optical processing on the second signal light;
a second convertor that is connected to the optical circuit and converts the second signal light that travels from the optical circuit and that is subjected to the first optical processing into third signal light with the first optical characteristic;
the optical circuit that, when the converted third signal light from the second convertor passes through the optical circuit, performs second optical processing on the third signal light; and
a second waveguide that outputs the third signal light that travels from the optical circuit and that is subjected to the second optical processing.

2. The optical device according to claim 1, wherein
the first convertor includes
a first port that is connected to the first waveguide;
a second port that is connected to the optical circuit; and
a third port that is connected to the second waveguide, and
the second convertor includes
a fourth port that is connected to the optical circuit;
a fifth port that is connected to one side of a folded waveguide that is connected to the second convertor; and
a sixth port that is connected to another side of the folded waveguide.

3. The optical device according to claim 1, wherein
the first optical characteristic and the second optical characteristic represent polarization states,
the first convertor includes
a first polarization rotator (PR) that is connected to the first waveguide and converts the first signal light that travels from the first waveguide into the second signal light; and
a first polarization beam splitter (PBS) that is connected to the first PR, that outputs the second signal light that travels from the first PR to the optical circuit, that is connected to the optical circuit, and that outputs the third signal light that travels from the optical circuit and that is subjected to the second optical processing to the second waveguide, and
the second convertor includes
a second PBS that is connected to the optical circuit and outputs the second signal light that travels from the optical circuit and that is subjected to the first optical processing to a second PR; and
the second PR that is connected to the second PBS, that converts the second signal light that travels from the second PBS and that is subjected to the first optical processing into the third signal light, and that outputs the converted third signal light to the second PBS in a folded manner, and
the second PBS outputs the converted third signal light that travels from the second PR to the optical circuit.

4. The optical device according to claim 3, wherein
the first PBS includes
a first port that is connected to the first PR;
a second port that is connected to the optical circuit; and
a third port that is connected to the second waveguide, and
the second PBS includes
a fourth port that is connected to the optical circuit;
a fifth port that is connected to the second PR that is connected to one side of the folded waveguide; and
a sixth port that is connected to another side of the folded waveguide.

5. The optical device according to claim 1, wherein
the first optical characteristic and the second optical characteristic represent polarization states,
the first convertor includes
a first polarization rotator (PR) that is connected to the first waveguide and converts the first signal light that travels from the first waveguide into the second signal light; and
a first polarization beam splitter (PBS) that is connected to the first PR, that outputs the second signal light that travels from the first PR to a port of the optical circuit,
the second convertor includes
a second PBS that is connected to the optical circuit, that outputs the second signal light that travels from the optical circuit and that is subjected to the first optical processing to a second PR, and that outputs the third signal light that travels from the optical circuit and that is subjected to the second optical processing to the second waveguide; and
the second PR that is connected to the second PBS, that converts the second signal light that travels from the second PBS and that is subjected to the first optical processing into the third signal light, that is connected to the first PBS, and that outputs the converted third signal light to the first PBS, and
the first PBS outputs the converted third signal light that travels from the second PR to the port of the optical circuit.

6. The optical device according to claim 5, wherein
the first PBS includes
a first port that is connected to the first PR;
a second port that is connected to the optical circuit; and
a third port that is connected to a folded waveguide that is connected to the second PR, and
the second PBS includes
a fourth port that is connected to the optical circuit;
a fifth port that is connected to the second PR; and
a sixth port that is connected to the second waveguide.

7. The optical device according to claim 1, wherein
the first optical characteristic and the second optical characteristic represent mode states,
the first convertor includes
a first mode convertor that is connected to the first waveguide, that performs mode conversion on the first signal light that travels from the first waveguide to obtain the second signal light, that is connected to the optical circuit, and that outputs the second signal light obtained by the mode conversion to the optical circuit,
the second convertor includes
a second mode convertor that is connected to the optical circuit, that performs mode conversion on the second signal light that travels from the optical circuit and that is subjected to the first optical processing to obtain the third signal light, that is connected to the optical circuit, and that outputs the third signal light obtained by the mode conversion to the optical circuit in a folded manner, and
the first mode convertor outputs the third signal light that travels from the optical circuit and that is subjected to the second optical processing to the second waveguide.

8. The optical device according to claim 7, wherein
the first mode convertor includes
a first port that is connected to the first waveguide;
a second port that is connected to the optical circuit; and
a third port that is connected to the second waveguide, and
the second mode convertor includes
a fourth port that is connected to the optical circuit;
a fifth port that is connected to one side of a folded waveguide; and
a sixth port that is connected to another side of the folded waveguide.

9. The optical device according to claim 1, wherein
the first optical characteristic and the second optical characteristic represent mode states,
the first convertor includes
a first mode convertor that is connected to the first waveguide, that performs mode conversion on the first signal light that travels from the first waveguide to obtain the second signal light, that is connected to the optical circuit, and that outputs the second signal light obtained by the mode conversion to a port of the optical circuit,
the second convertor includes
a second mode convertor that is connected to the optical circuit, that performs mode conversion on the second signal light that travels from the optical circuit and that is subjected to the first optical processing to obtain the third signal light, that is connected to the first mode convertor, that outputs the third signal light obtained by the mode conversion to the first mode convertor, and that outputs the third signal light that travels from the optical circuit and that is subjected to the second optical processing to the second waveguide, and
the first mode convertor outputs the first signal light that travels from the second mode convertor, that is subjected to the mode conversion, and that is subjected to the first optical processing to the port of the optical circuit.

10. The optical device according to claim 9, wherein
the first mode convertor includes
a first port that is connected to the first waveguide;
a second port that is connected to the optical circuit; and
a third port that is connected to a folded waveguide that is connected to the second mode convertor, and
the second mode convertor includes
a fourth port that is connected to the optical circuit;
a fifth port that is connected to the folded waveguide; and
a sixth port that is connected to the second waveguide.

11. The optical device according to claim 1, wherein
the optical circuit includes
a forward-side working part that includes a forward-side rib waveguide that is connected to the first convertor;
a backward-side working part that includes a backward-side rib waveguide that is connected to the second convertor; and
a folded waveguide that includes a rib waveguide that connects the forward-side working part and the backward-side working part.

12. The optical device according to claim 1, wherein
the optical circuit includes
a forward-side working part that includes a forward-side rib waveguide that is connected to the first convertor;
a backward-side working part including a backward-side rib waveguide that is connected to the second convertor; and
a folded waveguide that includes a channel waveguide that connects the forward-side working part and the backward-side working part.

13. The optical device according to claim 1, wherein
the optical circuit includes
a rib waveguide that connects the first convertor and the second convertor;
a first electrode that is electrically connected to a first slab of the rib waveguide; and
a second electrode that is electrically connected to a second slab of the rib waveguide,
the first slab includes
a first part that is located close to a rib of the rib waveguide; and
a second part that comes into contact with the first electrode,
the second part having higher doping concentration than the first part, and
the second slab includes
a first part that is located close to the rib waveguide; and
a second part that comes into contact with the second electrode,
the second part having higher doping concentration than the first part.

14. The optical device according to claim 1, wherein
the optical circuit includes
a forward-side working part that includes a forward-side rib waveguide that is connected to the first convertor;
a backward-side working part that includes a backward-side rib waveguide that is connected to the second convertor; and
a folded waveguide that includes a channel waveguide that connects the forward-side working part and the backward-side working part,
the forward-side working part includes
the forward-side rib waveguide that is connected to the first convertor;
a first electrode that is electrically connected to a first slab of the forward-side rib waveguide; and
a second electrode that is electrically connected to a second slab of the forward-side rib waveguide, and
the backward-side working part includes
the backward-side rib waveguide that is connected to the second convertor;
a first electrode that is electrically connected to a first slab of the backward-side rib waveguide; and
a second electrode that is electrically connected to a second slab of the backward-side rib waveguide.

15. The optical device according to claim 1, wherein
the optical circuit includes
a forward-side working part that includes a forward-side rib waveguide that is connected to the first convertor;
a backward-side working part that includes a backward-side rib waveguide that is connected to the second convertor; and
a folded waveguide that includes a channel waveguide that connects the forward-side working part and the backward-side working part, and
each of the forward-side working part and the backward-side working part includes
a first electrode that is electrically connected to a first slab of the forward-side rib waveguide and that is electrically connected to a first slab of the backward-side rib waveguide; and
a second electrode that is electrically connected to a second slab of the forward-side rib waveguide and that is electrically connected to a second slab of the backward-side rib waveguide.

16. The optical device according to claim 1, wherein the optical circuit is a variable attenuator that adjusts an attenuation amount of the signal light that passes, in accordance with an electric signal.

17. The optical device according to claim 1, wherein the optical circuit is a modulator that adjusts a modulation amount of the signal light that passes, in accordance with an electric signal.

18. The optical device according to claim 1, wherein the optical circuit is a phase shifter that adjusts a phase amount of the signal light that passes, in accordance with an electric signal.

19. An optical transmission apparatus comprising:
a light source that emits first signal light; and
an optical transmitter that performs optical processing on the first signal light that travels from the light source in accordance with an electric signal and transmits third signal light that is subjected to optical processing, wherein
the optical transmitter includes
a first waveguide that inputs the first signal light with a first optical characteristic;
a first convertort that is connected to the first waveguide and converts the first signal light that travels from the first waveguide into second signal light with a second optical characteristic;
an optical circuit that is connected to the first convertor, and when the converted second signal light from the first convertor passes through the optical circuit, performs first optical processing on the second signal light;
a second convertor that is connected to the optical circuit and converts the second signal light that travels from the optical circuit and that is subjected to the first optical processing into third signal light with the first optical characteristic;
the optical circuit that, when the converted third signal light from the second convertor passes through the optical circuit, performs second optical processing on the third signal light; and
a second waveguide that transmits the third signal light that travels from the optical circuit and that is subjected to the second optical processing.

20. An optical reception apparatus comprising:
a light source that emits first signal light;
an optical device that performs optical processing on the first signal light that travels from the light source in accordance with an electric signal and generates third signal light that is subjected to the optical processing; and
an optical receiver that obtains a received signal from reception light by using the third signal light that is subjected to the optical processing, wherein
the optical device includes
a first waveguide that inputs the first signal light with a first optical characteristic;
a first convertor that is connected to the first waveguide and converts the first signal light that travels from the first waveguide into second signal light with a second optical characteristic;
an optical circuit that is connected to the first convertor, and when the converted second signal light from the first convertor passes through the optical circuit, performs first optical processing on the second signal light;
a second convertor that is connected to the optical circuit and converts the second signal light that travels from the optical circuit and that is subjected to the first optical processing into third signal light with the first optical characteristic;
the optical circuit that, when the converted third signal light from the second convertor passes through the optical circuit, performs second optical processing on the third signal light; and
a second waveguide that outputs the third signal light that travels from the optical circuit and that is subjected to the second optical processing to the receiver.
